(19) United States
(12) Patent Application Publication
(10) Pub. No.: US 2005/0068621 A1
(43) Pub. Date: Mar. 31, 2005

(54) Projection screen and projection system comprising the same

(75) Inventor: Masanori Umeya, Tokyo-To (JP)

Correspondence Address: PARKHURST & WENDEL, L.L.P., 1421 PRINCE STREET, SUITE 210, ALEXANDRIA, VA, 22314-2805, US

(73) Assignee: Dai Nippon Printing Co., Ltd., Shinjuku-ku (JP)

(21) Appl. No.: 10/952,440

(22) Filed: Sep. 29, 2004

(30) Foreign Application Priority Data
Sep. 30, 2003 (JP) 2003-341233

(51) Int. Cl. G03B 21/60

(52) U.S. Cl. 359/459

(57) ABSTRACT

A projection screen includes: a cholesteric liquid crystalline, polarized-light selective reflection layer that selectively reflects a specific polarized-light component; and a substrate that supports the polarized-light selective reflection layer. Helical structure parts of the cholesteric liquid crystalline structure of the polarized-light selective reflection layer have such helical pitches continuously varied along the thickness of the layer that the polarized-light selective reflection layer has substantially the same reflectance for light in a predetermined wide wave range (e.g., a wave range of 450 to 650 nm).

### BACKGROUND OF THE INVENTION

1. Field of the Invention

The present invention relates to a projection system in which imaging light emitted from a projector is projected on a projection screen to display thereon an image. More particularly, the present invention relates to a projection screen capable of sharply displaying an image, and providing high image visibility, and to a projection system comprising such a projection screen.

2. Background Art

A conventional projection system is usually as follows: imaging light emitted from a projector is projected on a projection screen, and viewers observe the light reflected from the projection screen as an image.

Typical examples of projection screens for use in such conventional projection systems include white-colored paper or cloth materials, and plastic films coated with inks that scatter white light. Besides, high-quality projection screens that comprise scattering layers containing beads, pearlescent pigments, or the like, capable of controlling the scattering of imaging light, are now commercially available.

Since projectors have become smaller in size and moderate in price in recent years, demand for household projectors such as projectors for family theaters is growing, and an increasing number of families are now enjoying projection systems. Household projection systems are often placed in living rooms or the like, which are usually so designed that environmental light such as sunlight and light from lighting fixtures come in abundantly. Therefore, projection screens for use in household projection systems are expected to show good image display performance even under bright environmental light.

However, the above-described conventional projection screens cannot show good image display performance under bright environmental light because they reflect not only imaging light but also environmental light such as sunlight and light from lighting fixtures.

In such a conventional projection system, differences in the intensity of light (imaging light) projected on a projection screen from a projector cause light and shade to form an image. For example, in the case where a white image on a black background is projected, the projected-light-striking part of the projection screen becomes white and the other part becomes black; thus, differences in brightness between white and black cause light and shade to form the desired image. In this case, in order to attain excellent image display, it is necessary to make the contrast between the white- and black-indication parts greater by making the white-indication part lighter and the black-indication part darker.

However, since the above-described conventional projection screen reflects both imaging light and environmental light such as sunlight and light from lighting fixtures without distinction, both the white- and black-indication parts get lighter, and differences in brightness between white and black become small. For this reason, the conventional projection screen cannot satisfactorily provide good image display unless the influence of environmental light such as sunlight and light from lighting fixtures on the projection screen is suppressed by using a means for shading a room, or by placing the projection screen in a dark environment.

Under these circumstances, studies have been made on projection screens capable of showing good image display performance even under bright environmental light. There have so far been proposed projection screens using, for example, holograms or polarized-light-separating layers (see Japanese Laid-Open Patent Publications No. 107660/1993 (Patent Document 1) and No. 540445/2002 (Patent Document 2)).

Of these conventional projection screens, those ones using holograms have the advantage that the white-indication part can be made lighter if their light-scattering effect is properly controlled, so that they can show relatively good image display performance even under bright environment light. However, holograms have wavelength selectivity but no polarization selectivity, so that the projection screens using holograms can display images only with limited sharpness. Moreover, because of production problems, it is difficult to produce large-sized projection screens by making use of holograms.

On the other hand, on the above-described conventional projection screens using polarized-light-separating layers, it is possible to make the white-indication part lighter and the black-indication part darker. Therefore, these projection screens can sharply display images even under bright environmental light as compared with the projection screens using holograms.

Specifically, Patent Document 1 describes a projection screen for which a cholesteric liquid crystal that reflects red, green and blue light (right- or left-handed circularly polarized light) contained in imaging light is used in order to make the projection screen not reflect nearly half the environmental light incident on the screen, by making use of the circularly-polarized-light-separating property of the cholesteric liquid crystal.

However, in the projection screen described in Patent Document 1, since the cholesteric liquid crystal is in the state of planar orientation, specular reflection occurs when the cholesteric liquid crystal reflects light, which makes it difficult to recognize the reflected light as an image. Namely, to recognize the reflected light as an image, it is necessary that the reflected light be scattered. However, Patent Document 1 is quite silent on this point.

On the other hand, Patent Document 2 describes a projection screen using, as a reflective polarization element, a multi-layered reflective polarizer or the like, having diffusing properties. This projection screen does not reflect part of the environmental light that is incident on it because of the polarized-light-separating property of the multi-layered reflective polarizer, and scatters the reflected light by interfacial reflection that occurs at an interface between materials having different refractive indices, constituting the multi-layered reflective polarizer, or by means of a diffusing element that is provided separately from the multi-layered reflective polarizer. Further, Patent Document 2 describes a projection screen using a cholesteric, reflective polarizer or the like as a reflective polarization element in combination with a diffusing element. This projection screen does not reflect part of the environmental light that is incident on it because of the polarized-light-separating property of the cholesteric, reflective polarizer, and scatters the reflected light by means of the diffusing element that is provided separately from the cholesteric, reflective polarizer.

Namely, the projection screen described in Patent Document 2 is made to selectively diffuse-reflect only a specific polarized-light component of the imaging light projected from a projector by making use of the so-called polarized-light-separating property so that the projection screen sharply displays an image, and is made to further scatter the reflected imaging light so that the projection screen provides improved image visibility.

Further, the projection screen described in Patent Document 2 is made to selectively diffuse-reflect only light in a specific selective reflection wave range by making use of the wavelength selectivity of the polarized-light selective reflection layer.

The polarized-light selective reflection layer for use in such a projection screen is so designed that this layer reflects light in the wave ranges for red (R), green (G) and blue (B) colors (the three primary colors of light) so that the intensities of the reflected light are balanced, thereby displaying white color as white as possible and black color as black as possible. More specifically, on the assumption that imaging light enters the projection screen from the front (the position in which a projector is commonly set), the selective reflection wave range of the polarized-light selective reflection layer is designed so that the balance of intensity among light in the wave ranges for red (R), green (G) and blue (B) colors reflected from the polarized-light selective reflection layer (also called “white balance”) is well maintained.

In a place in which such a projection screen is set, environmental light such as sunlight and light from lighting fixtures is usually present. Such environmental light is usually emitted as white (that is, achromatic) light from an illuminant. Moreover, such environmental light (especially light from lighting fixtures) often obliquely enters the projection screen. In this case, the selective reflection wave range of the polarized-light selective reflection layer that reflects such environmental light looks as if it shifted to the shorter wavelength side (the so-called “blue shift” phenomenon occurs). Since the selective reflection wave range of the polarized-light selective reflection layer is so designed that this layer maintains a good white balance as long as imaging light enters the projection screen from the front, there is unfavorably produced a difference between the intensity of the environmental light that is reflected from the projection screen after obliquely entering it and the intensity of the imaging light that is reflected from the projection screen after entering it from the front. As a result, the balance of intensity among the reflected light in the wave ranges for red (R), green (G) and blue (B) colors (white balance) is disturbed.

Namely, if the above-described blue shift phenomenon occurs, even when environmental light emitted from an illuminant is achromatic, this environmental light reflected from the polarized-light selective reflection layer is not achromatic and is tinged with red, for example. Since the environmental light and imaging light reflected from the polarized-light selective reflection layer overlap each other, the image finally produced cannot maintain a good color balance (white balance) (for example, a white-indication part appears reddish white and a black-indication part, reddish gray) and has decreased image visibility.

It is noted that, by making a polarized component of environmental light different from the polarized-light component which the polarized-light selective reflection layer reflects, it is theoretically possible to make the polarized-light selective reflection layer never reflect the environmental light. Even in this case, however, it is difficult to make the degree of reflection of the environmental light exactly 0% (that is, to make the transmittance 100%), and is thus impossible to completely avoid the above-described problem.

### SUMMARY OF THE INVENTION

The present invention has been accomplished in the light of the above-described problem in the related art. An object of the present invention is, therefore, to provide a projection screen capable of sharply displaying an image even under bright environmental light, and providing improved image visibility, and to provide a projection system comprising such a projection screen.

A projection screen of the present invention, for displaying an image by reflecting imaging light that is projected from the observation side, comprises: a polarized-light selective reflection layer that selectively reflects a specific polarized-light component, wherein the polarized-light selective reflection layer has substantially the same reflectance for light in a wave range of at least 450 to 650 nm.

In the above-described projection screen according to the present invention, it is preferable that the polarized-light selective reflection layer has a selective reflection wave range whose width between the shorter and longer wavelength side ends, around the center wavelength, is 200 nm or more.

Further, in the above-described projection screen according to the present invention, it is preferable that the specific polarized-light component be right- or left-handed circularly polarized light. The specific polarized-light component may also be linearly polarized light of one vibration direction.

Furthermore, it is preferable that the above-described projection screen according to the present invention further comprises a diffusing element that diffuses light that is reflected from the polarized-light selective reflection layer, or that the polarized-light selective reflection layer itself has diffusing properties.

Furthermore, in the projection screen according to the present invention, it is preferable that the polarized-light selective reflection layer has a cholesteric liquid crystalline structure and, owing to structural non-uniformity in the cholesteric liquid crystalline structure, diffuses the specific polarized-light component. In this case, it is preferable that the cholesteric liquid crystalline structure of the polarized-light selective reflection layer contains a plurality of helical structure parts whose helical axes extend in different directions. It is also preferable that the cholesteric liquid crystalline structure of the polarized-light selective reflection layer has helical pitches that are continuously varied along the thickness of the layer.

Furthermore, in the projection screen according to the present invention, it is preferable that the polarized-light selective reflection layer be made from a material having a great birefringence value.

Furthermore, it is preferable that the projection screen according to the present invention further comprises a substrate that supports the polarized-light selective reflection layer. In this case, the substrate may be an absorptive substrate containing a light-absorbing layer adapted to absorb light in the visible region, or a transparent substrate adapted to transmit at least part of light in the visible region.

Furthermore, in the above-described projection screen according to the present invention, it is preferable that the polarized-light selective reflection layer comprises at least two laminated partial selective reflection layers having selective reflection wave ranges continuously overlapping each other, thereby having substantially the same reflectance for light in a wave range of at least 450 to 650 nm. In this case, it is preferable that an intermediate layer having barrier or adhesion properties be provided between each neighboring two of the partial selective reflection layers in the polarized-light selective reflection layer.

Furthermore, it is preferable that the projection screen according to the present invention further comprises a functional layer containing at least one layer selected from the group consisting of a hard coat layer, an anti-glaring layer, an anti-reflection layer, an ultraviolet-light-absorbing layer and an antistatic layer. In this case, the functional layer is preferably an anti-glaring layer, and this anti-glaring layer is preferably composed of a layer with an irregularly roughened surface, isotropic with respect to refractive index. For example, a TAC film with a matte surface is conveniently used as the anti-glaring layer.

Furthermore, in the above-described projection screen according to the present invention, it is preferable that the polarized-light selective reflection layer has, on the side on which imaging light is projected, a roughened surface, by which the anti-glaring property is imparted to the polarized-light selective reflection layer.

A projection system according to the present invention comprises: the above-described projection screen according to the present invention; and a projector that projects imaging light on the projection screen.

According to the present invention, (1) since the polarized-light selective reflection layer that selectively reflects a specific polarized-light component is made to have substantially the same reflectance for light in a wave range of at least 450 to 650 nm, this layer can reflect light while substantially maintaining the wavelength-dependent dispersion of the light as long as the wavelength of the light falls in a wave range between 450 nm and 650 nm. The reflection wave range of such a polarized-light selective reflection layer covers the wave ranges of the imaging light projected from a projector (the wave ranges for red (R), green (G) and blue (B) colors, the three primary colors of light). Moreover, in such a polarized-light selective reflection layer, the blue shift phenomenon does not occur because the imaging light enters the polarized-light selective reflection layer from the front. Therefore, the intensity of the imaging light projected from the projector becomes equal to the intensity of the imaging light reflected from the polarized-light selective reflection layer, and the original colors of the imaging light in the wave ranges for red (R), green (G) and blue (B) colors, the three primary colors of light, can thus be successfully reproduced. Further, since the polarized-light selective reflection layer has substantially the same reflectance for light in a wave range of 450 to 650 nm, even when the selective reflection wave range of the polarized-light selective reflection layer shifts to the shorter wavelength side, that is, the so-called blue shift phenomenon occurs, the intensity of environmental light in a wave range of at least 450 to 650 nm (in a wave rave range including the wave ranges for red (R), green (G) and blue (B) colors, the three primary colors of light) reflected from the polarized-light selective reflection layer can be kept approximately uniform. For this reason, even when environmental light obliquely enters the polarized-light selective reflection layer, this environmental light does not disturb the balance of intensity among the imaging light reflected from the polarized-light selective reflection layer, and the intensities of the reflected light in the wave ranges for red (R), green (G), and blue (B) colors, the three primary colors of light, remain balanced (a good white balance is maintained). Increased image visibility can thus be obtained.

(2) Further, if the polarized-light selective reflection layer is made to have a selective reflection wave range whose width between the shorter and longer wavelength side ends, around the center wavelength, is 200 nm or more, this layer can selectively reflect light in wave ranges with center wave lengths of 430-460 nm, 540-570 nm, and 580-620 nm when the light enters the polarized-light selective reflection layer vertically to it. In this case, it becomes possible to agree the selective reflection wave range of the projection screen with the wave ranges of the imaging light that is projected on the projection screen, and also to make the polarized-light selective reflection layer reflect light in a wave range of at least 450 to 650 nm, contained in environmental light. In this connection, it is noted that a projector that projects imaging light on the projection screen attains color display by using light in the wave ranges for red (R), green (G) and blue (B) colors, the three primary colors of light. For example, the projector projects light in the wave ranges with center wavelengths of 430-460 nm, 540-570 nm, and 580-620 nm, where the light enters the projection screen vertically to it.

(3) The polarized-light selective reflection layer selectively reflects only a specific polarized-light component (for example, right-handed circularly polarized light if the specific polarized-light component is either right- or left-handed circularly polarized light) owing to its polarized-light-separating property. It is, therefore, possible to make the polarized-light selective reflection layer reflect only approximately 50% of unpolarized environmental light, such as sunlight and light from lighting fixtures, incident on the polarized-light selective reflection layer. For this reason, while maintaining the brightness of the light-indication part such as a white-indication part, it is possible to lower the brightness of the dark-indication part such as a black-indication part to nearly half, thereby obtaining nearly twice-enhanced image contrast. In this case, if the imaging light to be projected is made to mainly contain a polarized-light component that is identical with the one which the polarized-light selective reflection layer selectively reflects (e.g., right-handed circularly polarized light), the polarized-light selective reflection layer can reflect nearly 100% of the imaging light projected, that is, the polarized-light selective reflection layer can efficiently reflect the imaging light. Even a projector that emits linearly polarized light, such as a liquid crystal projector, can be used, regardless of the direction of linear polarization, for projecting imaging light on the projection screen, if a retardation layer or the like for converting linearly polarized light into circularly polarized light is used.

(4) The specific polarized-light component which the polarized-light selective reflection layer selectively reflects may also be a linearly polarized light of one vibration direction (P- or S-polarized light). Also in this case, the polarized-light selective reflection layer selectively reflects only a specific polarized-light component (e.g., P-polarized light) owing to its polarized-light-separating property. It is, therefore, possible to make the polarized-light selective reflection layer reflect only approximately 50% of unpolarized environmental light, such as sunlight and light from lighting fixtures, incident on the polarized-light selective reflection layer. For this reason, while maintaining the brightness of the light-indication part such as a white-indication part, it is possible to lower the brightness of the dark-indication part such as a black-indication part to nearly half, thereby obtaining nearly twice-enhanced image contrast. In this case, if the imaging light to be projected is made to mainly contain a polarized-light component that is identical with the one which the polarized-light selective reflection layer selectively reflects (e.g., P-polarized light), the polarized-light selective reflection layer can reflect nearly 100% of the imaging light projected, that is, the polarized-light selective reflection layer can efficiently reflect the imaging light. In the case where the specific polarized-light component which the polarized-light selective reflection layer selectively reflects is linearly polarized light of one vibration direction, it is possible to brightly display an image by making the direction of linear polarization of light to be emitted from a projector agree with the direction of linear polarization of light which the polarized-light selective reflection layer diffuse-reflects.

(5) In the case where the projection screen further comprises, in addition to the polarized-light selective reflection layer, a diffusing element that diffuses light reflected from the polarized-light selective reflection layer, it is possible to scatter the imaging light reflected, thereby increasing image visibility. In this case, since the polarized-light-separating property and diffusing properties can be made independent of each other, they can be easily controlled.

(6) Further, the polarized-light selective reflection layer itself may have diffusing properties. In this case, the state of polarization of light incident on the polarized-light selective reflection layer is not disturbed, so that the light reflected from the polarized-light selective reflection layer can have high intensity. Specifically, when a diffusing element that cannot maintain the state of polarization of incident light is provided on the observation side of a reflective polarization element, light passes through the diffusing element before entering the reflective polarization element and the state of polarization of the light is disturbed (this is called “depolarization”). In this case, the light that passes through the diffusing element includes two types of light, environmental light (sunlight, etc.) and imaging light. When the state of polarization of environmental light is disturbed by the diffusing element, the light which the reflective polarization element inherently transmits is, owing to depolarization, converted into a light component which the reflective polarization element reflects, and is reflected from the reflective polarization element as unnecessary light. On the other hand, when the state of polarization of imaging light is disturbed by the diffusing element, the light which the reflective polarization element inherently reflects is, owing to depolarization, converted into a light component which the reflective polarization element does not reflect, and passes through the reflective polarization element. Because of these two phenomena, the original polarized-light-separating property is impaired, and image visibility cannot fully be improved. However, if the polarized-light selective reflection layer itself has diffusing properties, the above-described “depolarization” does not occur. It is, therefore, possible to improve image visibility while maintaining the polarized-light-separating property inherent in the polarized-light selective reflection layer.

(7) Preferably, the polarized-light selective reflection layer has a cholesteric liquid crystalline structure, and, owing to structural non-uniformity in the cholesteric liquid crystalline structure, diffuses a specific polarized-light component. In this case, since environmental light and imaging light that pass through the polarized-light selective reflection layer do not undergo the above-described “depolarization”, it is possible to improve image visibility while retaining the original polarized-light-separating property of the polarized-light selective reflection layer. Specifically, in the polarized-light selective reflection layer, if its cholesteric liquid crystalline structure is structurally non-uniform because, for example, the helical structure parts of the cholesteric liquid crystalline structure have helical axes extending in different directions, the polarized-light selective reflection layer reflects imaging light not by specular reflection but by diffuse reflection, and the reflected light can thus be readily recognized as an image. At this time, owing to structural non-uniformity in the cholesteric liquid crystalline structure, the polarized-light selective reflection layer diffuses light that is selectively reflected. Therefore, the polarized-light selective reflection layer can reflect a specific polarized-light component while diffusing it, and, at the same time, transmit the other light components without diffusing them.

(8) Preferably, the cholesteric liquid crystalline structure of the polarized-light selective reflection layer is made to have helical pitches that are continuously varied along the thickness of the layer. The relationship between the width Δλ of the selective reflection wave range and the birefringence value Δn can be described by the equation Δλ=Δn·p, where p is the helical pitch in the helical structure consisting of liquid crystalline molecules. Therefore, by continuously varying the helical pitch in the cholesteric liquid crystalline structure of the polarized-light selective reflection layer along thickness, it is possible to make the width Δλ of the selective reflection wave range great.

In the case where the cholesteric liquid crystalline structure of the polarized-light selective reflection layer is made from a chiral nematic liquid crystal, i.e., a mixture of a polymerizable, nematic liquid crystalline material and a chiral agent, the helical pitch p on the observation side is made either shorter or longer by continuously varying, along thickness, the content of the chiral agent that controls the helical pitch p in the polymerizable, nematic liquid crystalline material, thereby obtaining a polarized-light selective reflection layer (or a plurality of partial selective reflection layers constituting the polarized-light selective reflection layer) having helical pitches p that are continuously varied along the thickness of the layer.

Specifically, for example, a cholesteric liquid crystal solution containing a photopolymerization initiator is applied to a substrate to form thereon an uncured cholesteric liquid crystal layer; ultraviolet light is applied to this cholesteric liquid crystal layer with its observation side surface exposed to the atmosphere with an oxygen content of 10% or more at normal pressures; and the substrate is then heated while gradually decreasing the partial pressure of oxygen in this atmosphere. In this manner, there can be obtained a polarized-light selective reflection layer (or a plurality of partial selective reflection layers constituting the polarized-light selective reflection layer) having helical pitches p that are continuously varied along the thickness of the layer. In the above process, the quantity of ultraviolet light that is applied to the cholesteric liquid crystal layer in the above-described atmosphere is preferably about 1 to 10% of the quantity of ultraviolet light with which the cholesteric liquid crystal layer can be cured with the helical pitch p maintained constant.

(9) Furthermore, it is preferable to form the polarized-light selective reflection layer from a material having a great birefringence value. The relationship between the width Δλ of the selective reflection wave range and the birefringence value Δn can be described by the equation Δλ=Δn·p, where p is the helical pitch in the helical structure consisting of liquid crystalline molecules. Therefore, if a material with a great birefringence value Δn is used, the resulting polarized-light selective reflection layer can have a selective reflection wave range with a great width Δλ. In this case, a single polarized-light selective reflection layer (or a polarized-light selective reflection layer composed of a smaller number of partial selective reflection layers) can reflect both light in predetermined wave ranges (light in the wave ranges for red (R), green (G) and blue (B) colors, the three primary colors of light), contained in imaging light, and light in a predetermined wave range (light in a wave range of at least 450 to 650 nm), contained in environmental light.

(10) The polarized-light selective reflection layer that diffuse-reflects a specific polarized-light component may comprise at least two laminated partial selective reflection layers having selective reflection wave ranges continuously overlapping each other, thereby having substantially the same reflectance for light in a wave range of at least 450 to 650 nm. In this case, the polarized-light selective reflection layer can reflect light while substantially maintaining the wavelength-dependent dispersion of the light as long as the wavelength of the light falls in a wave range of 450 to 650 nm. For this reason, even when environmental light obliquely enters the polarized-light selective reflection layer, this environmental light does not disturb the balance of intensity among the imaging light reflected from the polarized-light selective reflection layer, and the intensities of the reflected light in the wave ranges for red (R), green (G) and blue (B) colors, the three primary colors of light, remain balanced (a good white balance is maintained). Increased image visibility can thus be obtained.

(11) Furthermore, a projection system comprising the above-described projection screen and a projector that projects imaging light on the projection screen can be herein used. In this case, it is possible to increase image contrast by suppressing the influence of environmental light such as sunlight and light from lighting fixtures by making use of the polarized-light-separating property of the polarized-light selective reflection layer in the projection screen, and, at the same time, by making use of structural non-uniformity in the cholesteric liquid crystalline structure of the polarized-light selective reflection layer, it is possible to scatter the imaging light that is reflected, without lowering image visibility. Moreover, the polarized-light selective reflection layer that selectively reflects a specific polarized-light component is made to have substantially the same reflectance for light in a wave range of at least 450 to 650 nm. Therefore, even when environmental light obliquely enters the polarized-light selective reflection layer, this environmental light does not disturb the balance of intensity among the imaging light reflected from the polarized-light selective reflection layer, and the intensities of the reflected light in the wave ranges for red (R), green (G) and blue (B) colors, the three primary colors of light, remain balanced (a good white balance is maintained). Increased image visibility can thus be obtained.

### BRIEF DESCRIPTION OF THE DRAWINGS

FIG. 1 is a diagrammatic sectional view showing a projection screen according to an embodiment of the present invention;

FIGS. 2A and 2B are illustrations for explaining the state of orientation of and optical function of a polarized-light selective reflection layer in the projection screen shown in FIG. 1;

FIG. 3 is a diagram showing a wavelength-dependent dispersion of imaging light projected from a projector;

FIG. 4 is a diagram showing a reflection wave-range of the polarized-light selective reflection layer in the projection screen shown in FIG. 1;

FIG. 5 is a diagrammatic sectional view showing a modification of the projection screen shown in FIG. 1;

FIG. 6 is a diagrammatic sectional view showing another modification of the projection screen shown in FIG. 1;

FIG. 7 is a diagrammatic sectional view showing a further modification of the projection screen shown in FIG. 1;

FIG. 8 is a diagrammatic sectional view showing a still further modification of the projection screen shown in FIG. 1;

FIG. 9 is a diagrammatic sectional view showing a yet further modification of the projection screen shown in FIG. 1;

FIG. 10 is a diagrammatic sectional view showing another modification of the projection screen shown in FIG. 1;

FIG. 11 is a diagrammatic sectional view showing a further modification of the projection screen shown in FIG. 1;

FIG. 12 is a diagrammatic sectional view showing a yet further modification of the projection screen shown in FIG. 1;

FIGS. 13A and 13B are illustrations for explaining the concept of image display in a projection system using the projection screen shown in FIG. 1;

FIGS. 14A and 14B are illustrations for explaining the concept of image display in a projection system using the projection screen of Comparative Example;

FIG. 15 is a diagram showing a reflection wave range of the polarized-light selective reflection layer in the projection screen shown in FIGS. 14A and 14B;

FIG. 16A is a diagrammatic sectional view showing a projection screen according to another embodiment of the present invention;

FIG. 16B is a diagram showing a reflection wave range of the polarized-light selective reflection layer in the projection screen shown in FIG. 16A;

FIGS. 17A and 17B are illustrations for explaining the concept of image display in projection systems using the projection screen shown in FIG. 16A;

FIG. 18 is a diagrammatic view showing a projection system comprising the projection screen shown in FIG. 1; and

FIG. 19 is a diagrammatic view showing another projection system comprising the projection screen shown in FIG. 1.

### DETAILED DESCRIPTION OF PREFERRED EMBODIMENTS

By referring to the accompanying drawings, embodiments of the present invention will be described hereinafter.

Projection Screen

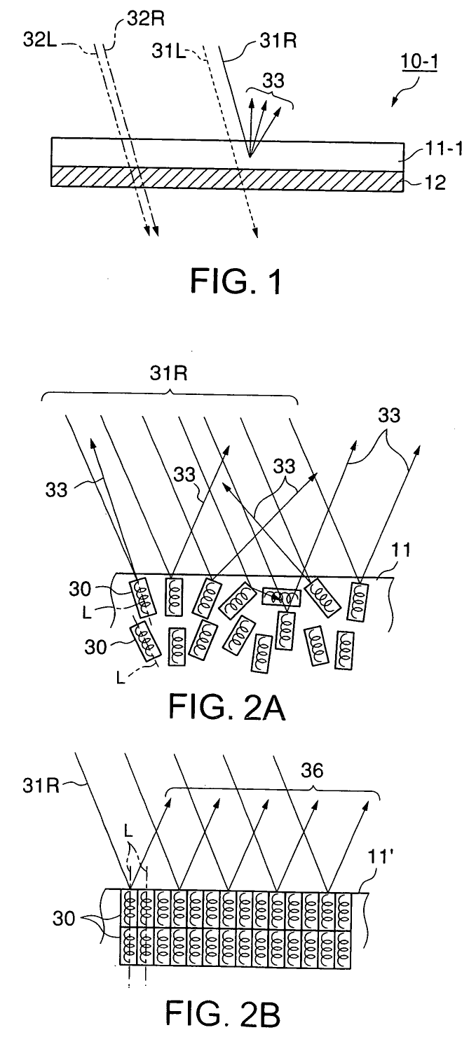

First of all, a projection screen according to an embodiment of the present invention will be described with reference to FIG. 1.

As shown in FIG. 1, a projection screen 10-1 according to this embodiment is for displaying an image by reflecting imaging light projected from the observation side (the upper side of the figure), and comprises a cholesteric liquid crystalline, polarized-light selective reflection layer 11-1 that selectively reflects a specific polarized-light component, and a substrate 12 that supports the polarized-light selective reflection layer 11-1.

The polarized-light selective reflection layer 11-1 is made from a cholesteric, liquid crystalline composition, and, liquid crystalline molecules in this layer are physically aligned in helical fashion in which the directors of the liquid crystalline molecules are continuously rotated in the direction of the thickness of the layer.

Owing to such a physical alignment of the liquid crystalline molecules, the polarized-light selective reflection layer 11-1 has the polarized-light-separating property, the property of separating a light component circularly polarized in one direction from a light component circularly polarized in the opposite direction. Namely, the polarized-light selective reflection layer 11-1 converts unpolarized light that enters the layer along the helical axis into light in two different states of polarization (right-handed circularly polarized light and left-handed circularly polarized light), and transmits one of these light and reflects the other. This phenomenon is known as circular dichroism. If the direction of rotation of liquid crystalline molecular helix is properly selected, a light component circularly polarized in the same direction as this direction of rotation is selectively reflected.

In this case, the scattering of polarized light is maximized at the wavelength λₒ given by the following equation (1):
λₒ=nav·p, (1)
where p is the helical pitch in the helical structure consisting of liquid crystalline molecules (the length of one liquid crystalline molecular helix), and nav is the mean refractive index on a plane perpendicular to the helical axis.

On the other hand, the width Δλ of the wave range in which the wavelength of light to be reflected falls is given by the following equation (2):
Δλ=Δn·p, (2)
where Δn is the value of birefringence.

Namely, as shown in FIG. 1, of the unpolarized light that has entered the projection screen 10-1 from the observation side and has been split into right-handed circularly polarized light 31R and left-handed circularly polarized light 31L in the selective reflection wave range and into right-handed circularly polarized light 32R and left-handed circularly polarized light 32L not in the selective reflection wave range, one of the circularly polarized-light components in the wave range (selective reflection wave range) with the width Δλ, centered at the wavelength λ0, (e.g., right-handed circularly polarized light 31R in the selective reflection wave range) is reflected from the projection screen 10-1 to be reflected light 33, and the other light (e.g., left-handed circularly polarized light 31L in the selective reflection wave range, and right-handed circularly polarized light 32R and left-handed circularly polarized light 32L not in the selective reflection wave range) pass through the projection screen 10-1, owing to the above-described polarized-light-separating property.

The cholesteric liquid crystalline structure of the polarized-light selective reflection layer 11-1 comprises a plurality of helical structure parts 30 that are different in the direction of the helical axis L, as shown in FIG. 2A. Owing to structural non-uniformity in such a cholesteric liquid crystalline structure, the polarized-light selective reflection layer 11-1 diffuses light that is selectively reflected (reflected light 33). The state in which the cholesteric liquid crystalline structure is structurally non-uniform herein includes: the state in which the helical structure parts 30 of the cholesteric liquid crystalline structure are different in the direction of the helical axis L; the state in which at least some of the planes of nematic layers (the planes on which the directors of liquid crystalline molecules point in the same X-Y direction) are not parallel to the plane of the polarized-light selective reflection layer 11-1 (the state in which, in a sectional TEM photo of a cholesteric liquid crystalline structure specimen that has been stained, continuous curves that appear as light-and-dark patterns are not parallel to the substrate plane); and the state in which finely divided particles of a cholesteric liquid crystal are dispersed in the cholesteric liquid crystalline structure as a pigment. The “diffusion” that is caused by such structural non-uniformity in the cholesteric liquid crystalline structure means that the light (imaging light) reflected from the projection screen 10-1 is spread or scattered to such an extent that viewers can recognize the reflected light as an image.

On the contrary, a conventional cholesteric liquid crystalline structure is in the state of planar orientation, and, as in a polarized-light selective reflection layer 11′ shown in FIG. 2B, the helical axes L of helical structure parts 30 of this cholesteric liquid crystalline structure extend in parallel in the direction of the thickness of the layer. Such a cholesteric liquid crystalline structure causes specular reflection when reflecting light that is selectively reflected (reflected light 36).

It is preferable that the helical structure parts 30 of the cholesteric liquid crystalline structure of the polarized-light selective reflection layer 11-1 has such helical pitches p continuously varied along the thickness of the layer that the polarized-light selective reflection layer 11-1 has substantially the same reflectance for light in a predetermined wide wave range (e.g., in a wave range of 450 to 650 nm). The reason for this is as follows: since the relationship between the width Δλ of the selective reflection wave range and the birefringence value Δn can be described by the above equation (2) (Δλ=Δn·p), the width Δλ of the selective reflection wave range can be made great (e.g., the width Δλ of the selective reflection wave range with a center wavelength λ₀ of 550 nm can be made 400 nm or more) if the cholesteric liquid crystalline structure of the polarized-light selective reflection layer 11-1 is made to have helical pitches p that are continuously varied along thickness.

The above-described predetermined wide wave range (e.g., a wave range of 450 to 650 nm) includes both the wave ranges of imaging light projected from a projector such as a liquid crystal projector (the wave ranges for red (R), green (G) and blue (B) colors, the three primary colors of light) and the wave ranges of environmental light such as sunlight and light from lighting fixtures.

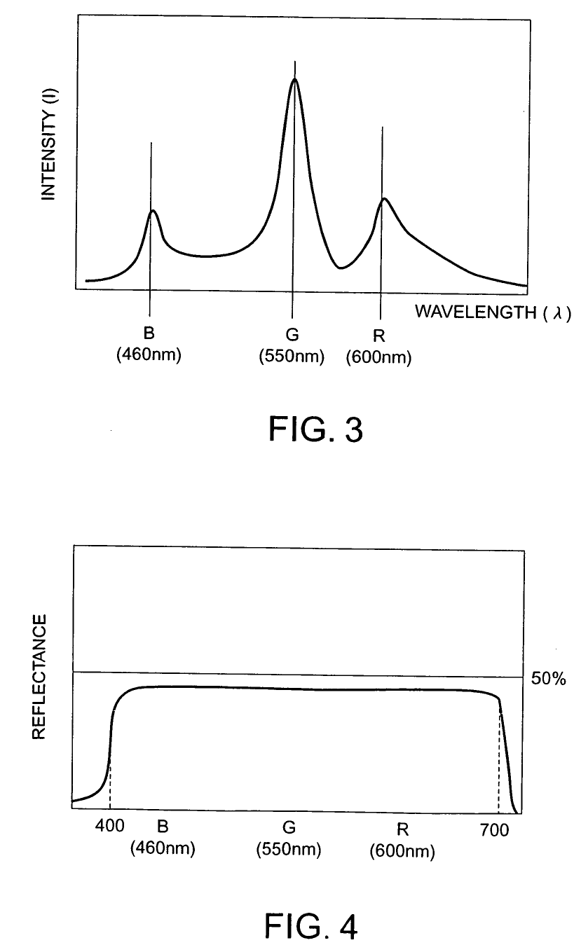

FIG. 3 is a diagram showing a wavelength-dependent dispersion of imaging light projected from a projector. FIG. 3 plots wavelength (λ) as the abscissa and intensity (I) as the ordinate.

A projector usually attains color display by using light in the wave ranges for red (R), green (G) and blue (B) colors, the primary three colors of light. Therefore, assuming that light enters the polarized-light selective reflection layer 11-1 vertically to it, it is preferable to decide the helical pitch p+ in the cholesteric liquid crystalline structure so that the polarized-light selective reflection layer 11-1 selectively reflects light in wave ranges with center wavelengths of 430-460 nm, 540-570 nm, and 580-620 nm.

The wave ranges of 430 to 460 nm, 540 to 570 nm, and 580 to 620 nm that are used as the red (R), green (G) and blue (B) color wave ranges, respectively, are commonly used for color filters, light sources, or the like for use in displays that produce white color by the three primary colors of light. Red (R), green (G) and blue (B) colors are shown as line spectra that peak at specific wavelengths (these specific wavelengths for blue (B), green (G), and red (R) colors are typically 460 nm, 550 nm, and 600 nm, respectively).

In the projection screen 10-1 according to this embodiment, the polarized-light selective reflection layer 11-1 has substantially the same reflectance (approximately 50%) for imaging light in a wave range of 400 to 700 nm, as shown in FIG. 4, as long as the wavelength-dependent dispersion of the imaging light is as described above. FIG. 4 plots wavelength (λ) as the abscissa and reflectance (R) as the ordinate. More specifically, the polarized-light selective reflection layer 11-1 has a selective reflection wave range whose width between the shorter and longer wavelength side ends, around the center wavelength, is 200 nm or more. For this reason, the polarized-light selective reflection layer 11-1 can reflect light while substantially maintaining the wavelength-dependent dispersion of the light as long as the wavelength of the light falls in a wave range of 400 to 700 nm (e.g., 450 to 650 nm).

The reflection wave range of such a polarized-light selective reflection layer 11-1 covers the wave ranges of imaging light projected from a projector (the wave ranges for red (R), green (G) and blue (B) colors, the three primary colors of light). Moreover, in such a polarized-light selective reflection layer 11-1, the blue shift phenomenon does not occur because the imaging light enters the polarized-light selective reflection layer 11-1 from the front. Therefore, the intensity of the imaging light projected from the projector becomes equal to the intensity of the imaging light reflected from the polarized-light selective reflection layer 11-1, and the original colors of the imaging light in the red (R), green (G) and blue (B) color wave ranges can thus be successfully reproduced. Further, since the polarized-light selective reflection layer 11-1 has substantially the same reflectance for light in a wave range of 450 to 650 nm, even if the selective reflection wave range of the polarized-light selective reflection layer 11-1 shifts to the shorter wavelength side, that is, the so-called blue shift phenomenon occurs, the intensity of environmental light in a wave range of at least 450 to 650 nm (in a wave range including the wave ranges for red (R), green (G) and blue (B) colors), reflected from the polarized-light selective reflection layer 11-1, can be kept approximately uniform. For this reason, the original color of achromatic environmental light emitted from an illuminant, such as sunlight and light from lighting fixtures, can be successfully reproduced, and it is thus possible to prevent coloring of the environmental light that is realized when an image including a white or black part is produced (e.g., a white part appears reddish white, and a black part, reddish gray). Therefore, even when environmental light obliquely enters the polarized-light selective reflection layer 11-1, this environmental light does not disturb the balance of intensity among the imaging light reflected from the polarized-light selective reflection layer 11-1, and the intensities of the reflected light in the wave ranges for red (R), green (G) and blue (B) colors remain balanced (a good white balance is maintained). Namely, it is possible to prevent the color of the polarized-light selective reflection layer 11-1 (the color of the foundation of the projection screen 10-1) from becoming blue, reddish purple, or the like, thereby enhancing image visibility.

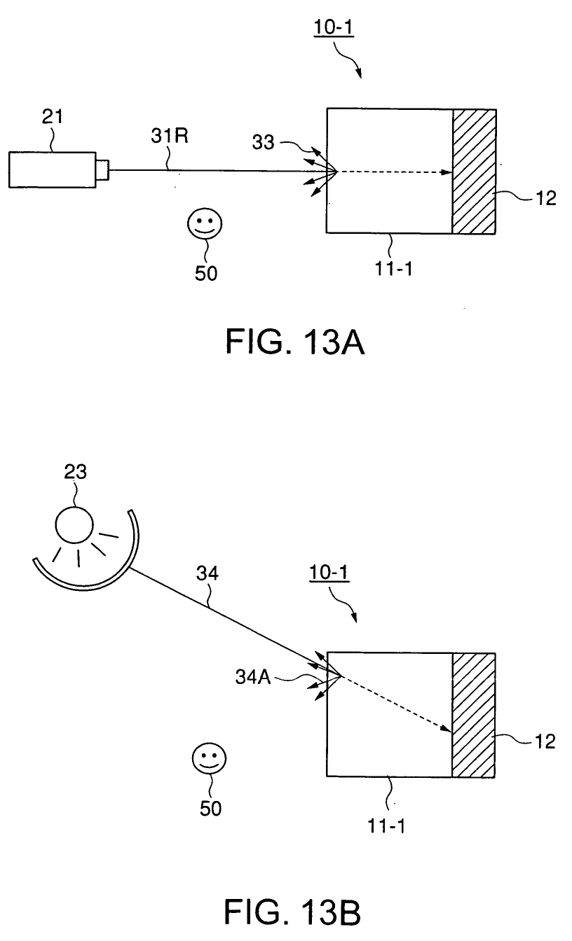

The optical function of the projection screen 10-1 comprising the polarized-light selective reflection layer 11-1 of the above-described construction will be described with reference to FIGS. 13A and 13B.

As shown in FIG. 13A, a projector 21 is placed on the observation side (the side on which a viewer 50 makes observation) of the projection screen 10-1, around the normal to the center portion of the projection screen 10-1. Imaging light (right-handed circularly polarized light 31R in the selective reflection wave range) projected from the projector 21 enters the projection screen 10-1 from the front. In this case, the imaging light projected from the projector 21 is right-handed circularly polarized light 31R in the selective reflection wave range the polarized-light selective reflection layer 11-1 in the projection screen 10-1 reflects, so that the diffuse-reflection of the imaging light occurs inside the polarized-light selective reflection layer 11-1 owing to the polarized-light-separating property, wavelength selectivity and scattering property of the cholesteric liquid crystalline structure of the polarized-light selective reflection layer 11-1. As a result, reflected light 33 are produced.

As mentioned above, since the polarized-light selective reflection layer 11-1 has substantially the same reflectance (approximately 50%) for light in a wave range of 400 to 700 nm, this layer 11-1 can reflect light while substantially maintaining the wavelength-dependent dispersion of the light as long as the wavelength of the light falls in a wave range of 400 to 700 nm. The reflection wave range of such a polarized-light selective reflection layer 11-1 covers the wave ranges of the imaging light (right-handed circularly polarized light 31R in the selective reflection wave range) projected from the projector 21 (the wave ranges for red (R), green (G) and blue (B) colors, the three primary colors of light). Moreover, in such a polarized-light selective reflection layer 11-1, the blue shift phenomenon does not occur because the imaging light (right-handed circularly polarized light 31R in the selective reflection wave range) enters the polarized-light selective reflection layer 11-1 from the front. Therefore, the intensity of the imaging light (right-handed circularly polarized light 31R in the selective reflection wave range) projected from the projector 21 becomes equal to the intensity of the imaging light reflected from the polarized-light selective reflection layer 11-1 (the intensity of the reflected light 33). The original colors of the imaging light in the wave ranges for red (R), green (G) and blue (B) colors can thus be successfully reproduced.

On the other hand, an illuminant 23 is, as shown in FIG. 13B, set on the observation side (the side on which a viewer 50 makes observation) of and diagonally above the projection screen 10-1, where light 34 emitted from the illuminant 23 obliquely enters the projection screen 10-1. Since the light 34 emitted from the illuminant 23 (a lighting fixture emitting unpolarized light, such as a fluorescent lamp) is, for example, unpolarized, achromatic light (light in a wide wave range of, for example, 450 to 650 nm), the diffuse-reflection of this light 34 occurs inside the polarized-light selective reflection layer 11-1 owing to the polarized-light-separating property, wavelength selectivity and scattering property of the cholesteric liquid crystalline structure of the polarized-light selective reflection layer 11-1. As a result, reflected light 34A are produced.

As mentioned above, since the polarized-light selective reflection layer 11-1 has substantially the same reflectance (approximately 50%) for light in a wave range of 400 to 700 nm, even if the selective reflection wave range of the polarized-light selective reflection layer 11-1 shifts to the shorter wavelength side, that is, the so-called blue shift phenomenon occurs, the intensity of the environmental light in a wave range of at least 450 to 650 nm (in a wave range including the wave ranges for red (R), green (G) and blue (B) colors, the three primary colors) reflected from the polarized-light selective reflection layer 11-1 can be kept approximately uniform. Therefore, the original color of the achromatic light 34 emitted from the illuminant 23 can be successfully reproduced, and it is possible to prevent coloring of this light 34 that is realized when an image including a white or black part is produced (e.g., a white part appears reddish white, and a black part, reddish gray). For this reason, when the light 34 from the illuminant 23 obliquely enters the polarized-light selective reflection layer 11-1, this light 34 does not disturb the balance of intensity among the imaging light (right-handed circularly polarized light 31R in the selective reflection wave range) reflected from the polarized-light selective reflection layer 11-1, and the intensities of the reflected light in the wave ranges for red (R), green (G) and blue (B) colors remain balanced (a good white balance is maintained). Namely, it is possible to prevent the color of the polarized-light selective reflection layer 11-1 (the color of the foundation of the projection screen 10-1) from becoming blue, reddish purple, or the like, thereby enhancing image visibility.

The intensity of the imaging light (right-handed circularly polarized light 31R in the selective reflection wave range) reflected from the polarized-light selective reflection layer 11-1 (the intensity of the reflected light 33) is determined by the reflected light 33 and the light passing through the substrate 12 (see the broken line in FIG. 13A). Similarly, the intensity of the light 34 emitted from the illuminant 23 and reflected from the polarized-light selective reflection layer 11-1 (the intensity of the reflected light 34A) is determined by the reflected light 34A and the light passing through the substrate 12 (see the broken line in FIG. 13B).

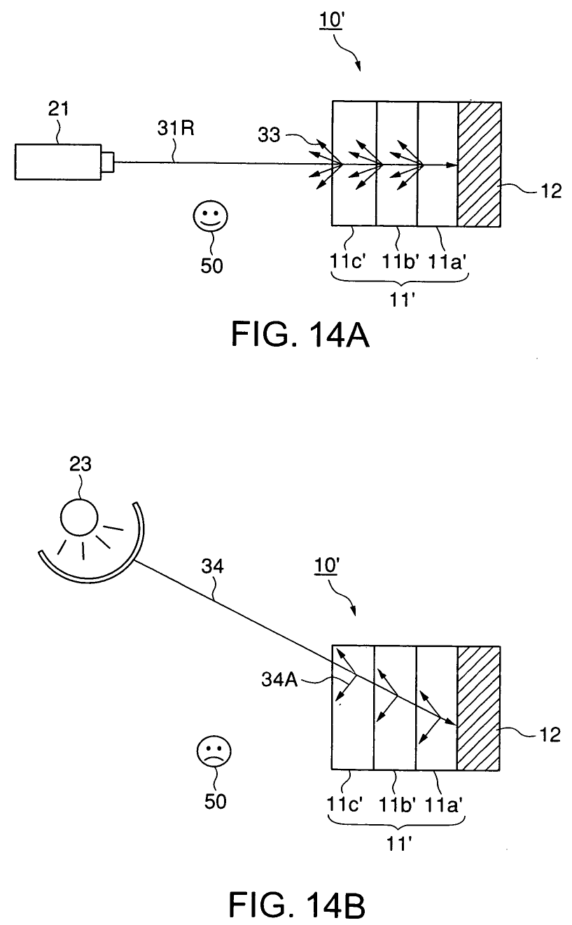

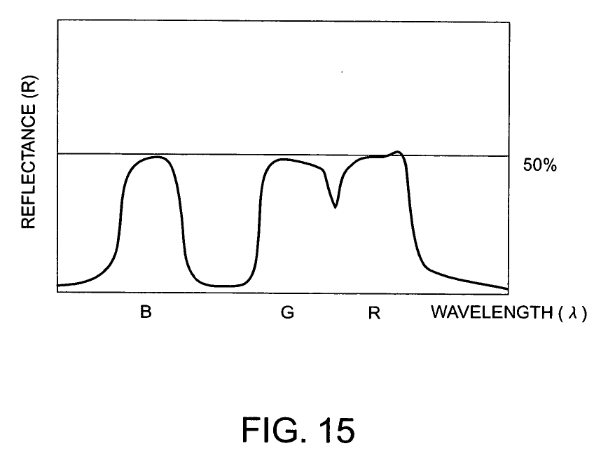

For comparison, the optical function of a projection screen 10′ comprising a polarized-light selective reflection layer 11′ having a reflection wave range equivalent to the wave range of the imaging light projected from the projector 21 will be described with reference to FIGS. 14A, 14B and 15.

As shown in FIG. 14A, the projection screen 10′ comprises a cholesteric liquid crystalline, polarized-light selective reflection layer 11′ that selectively reflects a specific polarized-light component, and a substrate 12 that supports the polarized-light selective reflection layer 11′.

The polarized-light selective reflection layer 11′ is composed of three laminated partial selective reflection layers 11a′, 11b′ and 11c′ having different helical pitches so that this layer 11′ selectively reflects only light in wave ranges identical with those of the imaging light projected from the projector 21. A projector 21 usually attains color display by using light in the wave ranges for red (R), green (G) and blue (B) colors, the primary three colors of light. Therefore, assuming that light enters the polarized-light selective reflection layer 11′ vertically to it, it is preferable to decide the helical pitches p in the cholesteric liquid crystalline structures of the three partial selective reflection layers 11a′, 11b′ and 11c′ so that the polarized-light selective reflection layer 11′ selectively reflects light in wave ranges with center wavelengths of 430-460 nm, 540-570 nm, and 580-620 nm.

Each partial selective reflection layer 11a′, 11b′, 11c′ in the polarized-light selective reflection layer 11′ can have any reflection wave range. For example, the selective reflection wave ranges of the partial selective reflection layers 11a′, 11b′ and 11c′ may be independently identical with the wave ranges for red (R), green (G) and blue (B) colors, the three primary colors of light, as shown in FIG. 15. FIG. 15 plots wavelength (λ) as the abscissa and reflectance (R) as the ordinate.

As shown in FIG. 14A, a projector 21 is placed on the observation side (the side on which a viewer 50 makes observation) of the projection screen 10′, around the normal to the center portion of the projection screen 10′. Imaging light (right-handed circularly polarized light 31R in the selective reflection wave range) projected from the projector 21 enters the projection screen 10′ from the front. In this case, the imaging light projected from the projector 21 is right-handed circularly polarized light 31R in the selective reflection wave range which the polarized-light selective reflection layer 11′ in the projection screen 10′ reflects, so that the diffuse-reflection of this light occurs inside the polarized-light selective reflection layer 11′ owing to the polarized-light-separating property, wavelength selectivity and scattering property of the cholesteric liquid crystalline structure of the polarized-light selective reflection layer 11′. As a result, reflected light 33 are produced. At this time, since the above-described imaging light (right-handed circularly polarized light 31R) is slightly disturbed in the state of polarization while passing through the polarized-light selective reflection layer 11′, it is assumed that part of the imaging light is reflected by interfacial reflection that occurs at interfaces between each neighboring two of the partial selective reflection layers 11a′, 11b′ and 11c′ (three interfaces, in this case).

The reflection wave range of the polarized-light selective reflection layer 11′ covers the wave ranges of the imaging light projected from the projector 21 (the wave ranges for red (R), green (G) and blue (B) colors, the three primary colors of light). Moreover, in the polarized-light selective reflection layer 11′, the blue shift phenomenon does not occur because the imaging light (right-handed circularly polarized light 31R in the selective reflection wave range) enters the polarized-light selective reflection layer 11′ from the front. Therefore, the intensity of the imaging light (right-handed circularly polarized light 31R in the selective reflection wave range) projected from the projector 21 becomes equal to the intensity of the imaging light reflected from the polarized-light selective reflection layer 11′ (the intensity of the reflected light 33). The original colors of the imaging light can thus be successfully reproduced.

On the other hand, an illuminant 23 is, as shown in FIG. 14B, set on the observation side (the side on which a viewer 50 makes observation) of and diagonally above the projection screen 10′, where light 34 emitted from the illuminant 23 obliquely enters the projection screen 10′. In this case, the light 34 emitted from the illuminant 23 (a lighting fixture emitting unpolarized light, such as a fluorescent lamp) is, for example, unpolarized, achromatic light (light in a wide wave range of, for example, 450 to 650 nm), so that the diffuse-reflection of this light 34 occurs inside the polarized-light selective reflection layer 11′ owing to the polarized-light-separating property, wavelength selectivity and scattering property of the cholesteric liquid crystalline structure of the polarized-light selective reflection layer 11′. As a result, reflected light 34A are produced. In the case where the projection system is used in a room or the like, not only the light 34 emitted from the illuminant 23 but also environmental light such as sunlight is present. Even in this case, the basic actions of such environmental light is the same as those of the light 34 emitted from the illuminant 23, so that explanation for them are herein omitted.

As shown in FIG. 14B, when the unpolarized, achromatic light 34 emitted from the illuminant 23 obliquely enters the projection screen 10′, the reflection wave range of the polarized-light selective reflection layer 11′ (the selective reflection wave ranges of the partial selective reflection layers 11a′, 11b′ and 11c′) looks as if it shifted to the shorter wavelength side (the so-called “blue shift” phenomenon occurs).

The reflection wave range of the polarized-light selective reflection layer 11′ (the selective reflection wave range of each partial selective reflection layer 11a′, 11b′, 11c′) is so designed that this layer 11′ keeps a good white balance as long as the imaging light enters the projection screen 10′ from the front. Therefore, when the light 34 emitted from the illuminant 23 obliquely enters the projection screen 10′ and the reflection wave range of the polarized-light selective reflection layer 11′ (the selective reflection wave range of each partial selective reflection layer 11a′, 11b′, 11c′) shifts to the shorter wavelength side, that is, the blue shift phenomenon occurs, the wave range of the light 34 that is originally outside the reflection wave range of the polarized-light selective reflection layer 11′ comes to be included in this reflection wave range. As a result, the light 34 that should not be reflected from the polarized-light selective reflection layer 11′ is reflected from this layer 11′, and the balance of intensity among the reflected light in the wave ranges for red (R), green (G) and blue (B) colors (white balance) is disturbed.

Namely, if the above-described blue shift phenomenon occurs, even when the light 34 emitted from the illuminant 23 is achromatic, the reflected light 34A, the light 34 reflected from the polarized-light selective reflection layer 11′, is not achromatic and is tinged with red, for example. The reflected light 34A, the light 34 reflected from the polarized-light selective reflection layer 11′, and the reflected light 33, the imaging light (right-handed circularly polarized light 31R in the selective reflection wave range) projected from the projector 21 and reflected from the polarized-light selective reflection layer 11′, overlap each other. As a result, the image finally produced is poor in color balance (white balance) (for example, a white-indication part appears reddish white and a black-indication part, reddish gray) and poor in image visibility.

The color of the polarized-light selective reflection layer 11′ (the color of the foundation of the projection screen 10′) is determined by the balance of intensity among the reflected light in the wave ranges for red (R), green (G) and blue (B) colors (white balance), as mentioned above. If the reflected light have balanced intensities, the color of the polarized-light selective reflection layer 11′ (the color of the foundation of the projection screen 10′) is achromatic, and there can be produced perfect white or black color, for example. On the contrary, the balance of intensity among the reflected light in the wave ranges for red (R), green (G) and blue (B) colors is disturbed, the color of the polarized-light selective reflection layer 11′ (the color of the foundation of the projection screen 10′) becomes blue, reddish purple, or the like, as described above.

The intensity of the light 34 reflected from the polarized-light selective reflection layer 11′ (the intensity of the reflected light 34A) varies depending on the wavelength selectivity of the polarized-light selective reflection layer 11′. For example, if the wave range of the light 34 is outside the reflection wave range of the polarized-light selective reflection layer 11′, most part of the light 34 passes through the polarized-light selective reflection layer 11′. However, even in such a case, it is difficult to make the degree of reflection of the light 34 (the intensity of the reflected light 34A) exactly 0% (that is, to make the transmittance 100%). As a result, there is unfavorably produced a difference between the intensity of the light 34 reflected from the projection screen 10′ (the intensity of the reflected light 34A) and the intensity of the imaging light (right-handed circularly polarized light 31R in the selective reflection wave range) reflected from the projection screen 10′ after entering it from the front (the intensity of the reflected light 33), and the balance of intensity among the reflected light in the wave ranges for red (R), green (G) and blue (B) colors (white balance) is disturbed.

The polarized-light-separating property of the polarized-light selective reflection layer 11′ governs the intensity of the light 34 reflected from the polarized-light selective reflection layer 11′ (the intensity of the reflected light 34A). Therefore, by making the light 34 contain a polarized component different from the polarized-light component which the polarized-light selective reflection layer 11′ reflects (that is, left-handed circularly polarized light), it is theoretically possible to make the polarized-light selective reflection layer 11′ never reflect the light 34. Even in this case, however, it is difficult to make the degree of reflection of the light 34 (the intensity of the reflected light 34A) exactly 0% (that is, to make the transmittance 100%). As a result, a difference is unfavorably produced between the intensity of the light 34 reflected from the projection screen 10′ (the intensity of the reflected light 34A) and the intensity of the imaging light (right-handed circularly polarized light 31R in the selective reflection wave range) reflected from the projection screen 10′ after entering it from the front (the intensity of the reflected light 33), and the balance of intensity among the reflected light in the wave ranges for red (R), green (G) and blue (B) colors (white balance) is disturbed.

In the above embodiment, the polarized-light selective reflection layer 11-1 is made to have a selective reflection wave range with a great width Δλ by making the cholesteric liquid crystalline structure of this layer 11-1 have helical pitches p that are continuously varied along thickness. Instead of this, the polarized-light selective reflection layer 11-1 may be made from a material having a great birefringence value Δn. Specifically, although a liquid crystalline composition having a birefringence value Δn of approximately 0.1 is usually used to form the polarized-light selective reflection layer 11-1, if a liquid crystalline composition having a birefringence value Δn of approximately 0.3 is used, the resulting polarized-light selective reflection layer 11-1 can have substantially the same reflectance for light in a predetermined wide wave range (e.g., a wave range of 450 to 650 nm).

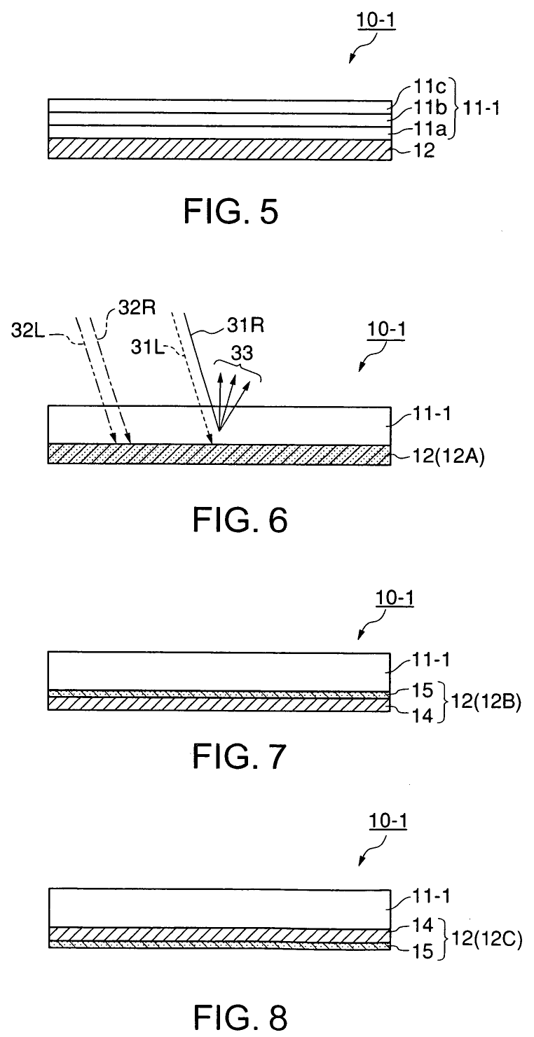

As described above, the polarized-light selective reflection layer 11-1 is composed of a single partial selective reflection layer having substantially the same reflectance for light in a predetermined wide wave range (e.g., in a wave range of 450 to 650 nm). However, if it is impossible to cover a wave range as wide as the above-described one (e.g., a wave range of 450 to 650 nm) by a single partial selective reflection layer, the polarized-light selective reflection layer 11-1 may be formed by laminating at least two partial selective reflection layers. Specifically, as shown in FIG. 5, the polarized-light selective reflection layer 11-1 may be produced by successively laminating, from the substrate 12 side, three partial selective reflection layers 11a, 11b and 11c, each partial selective reflection layer having a selective reflection wave range with a width Δλ increased to some extent. The partial selective reflection layers 11a, 11b and 11c have different selective reflection wave ranges continuously overlapping one another, and each layer has substantially the same reflectance for light in a wave range of at least 450 to 650 nm. Each partial selective reflection layer 11a, 11b, 11c has a cholesteric liquid crystalline structure adapted to selectively reflect a specific polarized-light component (e.g., right-handed circularly polarized light), and, owing to structural non-uniformity in the cholesteric liquid crystalline structure, diffuses light that is selectively reflected, like the polarized-light selective reflection layer 11-1 shown in FIGS. 1 and 2A. It is possible to control the reflection wave range (the center wavelength of the selective reflection wave range) of each partial selective reflection layer 11a, 11b, 11c by varying the chiral power by changing the type of the chiral agent to be added to a liquid crystalline composition for forming the partial selective reflection layer, or by varying the chiral agent content of the liquid crystalline composition.

It is preferable that the polarized-light selective reflection layer 11-1 (or each partial selective reflection layer 11a, 11b, 11c constituting the polarized-light selective reflection layer 11-1) be made to have such a thickness that it can reflect approximately 100% of light in a specific state of polarization that is selectively reflected (such a thickness that the reflectance is saturated). This is because when the polarized-light selective reflection layer 11-1 has a reflectance of less than 100% for a specific polarized-light component that is selectively reflected (e.g., right-handed circularly polarized light), this layer cannot efficiently reflect imaging light. Although the reflectance of the polarized-light selective reflection layer 11-1 (or each partial selective reflection layer 11a, 11b, 11c constituting the polarized-light selective reflection layer 11-1) depends directly on the number of helical turns, it depends indirectly on the thickness of the polarized-light selective reflection layer 11-1 if the helical pitch is fixed. Specifically, since it is said that approximately 4 to 8 helical turns are needed to obtain a reflectance of 100%, one partial selective reflection layer that reflects light in the red (R), green (G) or blue (B) color wave range is required to have a thickness of approximately 1 to 10 μm although this thickness varies depending on the type of the components of the liquid crystalline composition used for forming this layer and also on the selective reflection wave range of this layer. Further, the polarized-light selective reflection layer 11-1, composed of a single layer, reflecting light in a wave range of at least 450 to 650 nm, requires to have a thickness of approximately 1-20 μm.

On the other hand, the polarized-light selective reflection layer 11-1 (or each partial selective reflection layer 11a, 11b, 11c constituting the polarized-light selective reflection layer 11-1) should not be made thick limitlessly because if the layer is excessively thick, it becomes difficult to control the orientation of the layer, the layer cannot be made uniform, and the material itself for the layer absorbs light to a greater extent. For this reason, a thickness in the above-described range is proper for the polarized-light selective reflection layer 11-1 (or each partial selective reflection layer 11a, 11b, 11c).

Next, explanation for the substrate 12 will be given below.

The substrate 12 is for supporting the polarized-light selective reflection layer 11-1, and a material selected from plastic films, metals, paper, cloth, glass, and the like can be used for forming the substrate 12.

It is preferable that the substrate 12 comprises a light-absorbing layer adapted to absorb light in the visible region.

Specifically, for example, the substrate 12 (12A) may be made of a plastic film in which a black pigment is incorporated (e.g., a black PET film in which carbon is incorporated), as shown in FIG. 6. In this case, the substrate 12 (12A) itself serves as a light-absorbing layer (light-absorptive substrate). Such a substrate 12 absorbs those unpolarized light entering the projection screen 10-1 from the observation side that are inherently not reflected from the projection screen 10-1 as reflected light 33 (left-handed circularly polarized light 31L in the selective reflection wave range, and right-handed circularly polarized light 32R and left-handed circularly polarized light 32L not in the selective reflection wave range) and the light that enters the projection screen 10-1 from the backside. It is, therefore, possible to effectively prevent reflection of environmental light such as sunlight and light from lighting fixtures and production of stray light from imaging light.

The embodiment of the substrate 12 (12A) is not limited to the one shown in FIG. 6. The substrate 12 (12B, 12C) may also be obtained in the following manner: a light-absorbing layer 15 comprising a black pigment or the like is formed on one surface of a transparent support film 14 such as a plastic film, as shown in FIGS. 7 and 8.

To make the substrate 12 windable, it is preferable to make the thickness of the substrate 12, 15 to 300 μm, more preferably 25 to 100 μm. On the other hand, when the substrate 12 is not required to have flexibility as in the case where the projection screen is used as a panel, the thickness of the substrate 12 can be made great limitlessly.

Examples of plastic films that can be used as materials for the substrate 12 or the support film 14 include films of such thermoplastic polymers as polycarbonate polymers, polyester polymers including polyethylene terephthalate, polyimide polymers, polysulfone polymers, polyether sulfone polymers, polystyrene polymers, polyolefin polymers including polyethylene and polypropylene, polyvinyl alcohol polymers, cellulose acetate polymers, polyvinyl chloride polymers, polyacrylate polymers, and polymethyl methacrylate polymers. Materials for the substrate 12 or the support film 14 are not limited to the above-enumerated polymers, and it is also possible to use such materials as metals, paper, cloth and glass.

Lamination of the polarized-light selective reflection layer 11-1 to the substrate 12 is usually conducted by applying a cholesteric liquid crystalline composition and then subjecting the applied layer to aligning treatment and curing treatment, as will be described later.

In this lamination process, since it is necessary to make the cholesteric liquid crystalline structure of the polarized-light selective reflection layer 11-1 not in the state of planar orientation, it is preferable to use, as the substrate 12, a material whose surface to which the liquid crystalline composition will be applied has no aligning power.

However, even when a material whose surface to which the liquid crystalline composition will be applied has aligning power like a stretched film is used as the substrate 12, the cholesteric liquid crystalline structure of the polarized-light selective reflection layer 11-1 can be made not in the state of planar orientation if this surface of the material is subjected in advance to surface treatment, or if the components of the liquid crystalline composition are properly selected, or if the conditions under which the liquid crystalline composition is oriented are controlled.

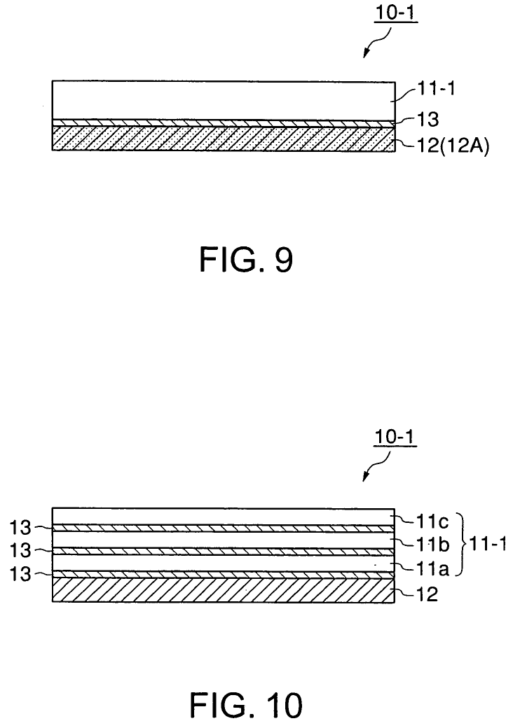

Further, even if a material whose surface to which the liquid crystalline composition will be applied has aligning power is used as the substrate 12, it is possible to control the orientation of the cholesteric liquid crystalline structure of the polarized-light selective reflection layer 11-1 by providing an intermediate layer 13, such as an adherent layer, between the substrate 12 (12A) and the polarized-light selective reflection layer 11-1, as shown in FIG. 9, thereby directing, to a plurality of directions, the directors of liquid crystalline molecules constituting the cholesteric liquid crystalline structure of the polarized-light selective reflection layer 11-1, existing in the vicinity of the intermediate layer 13. By providing an intermediate layer 13 such as an adherent layer, it is also possible to improve the adhesion between the polarized-light selective reflection layer 11-1 and the substrate 12. For such an intermediate layer 13, any material can be used as long as it is highly adherent to both the material for the polarized-light selective reflection layer 11-1 and the material for the substrate 12, and it is possible to use commercially available materials. Specific examples of materials that can be used for the intermediate layer 13 include an adherent-layer-containing PET film A4100 manufactured by Toyobo Co., Ltd., Japan and adherent materials AC-X, AC-L and AC-W manufactured by Panack Co., Ltd., Japan. A black pigment or the like may be incorporated in the intermediate layer 13, thereby using the intermediate layer 13 as a light-absorbing layer adapted to absorb light in the visible region, as in the case of the substrate 12 (12A) shown in FIG. 6. When the polarized-light selective reflection layer 11-1 is composed of a plurality of the partial selective reflection layers 11a, 11b and 11c that are laminated to the substrate 12, the intermediate layer 13 such as an adherent layer may be provided between each neighboring two of the partial selective reflection layers 11a, 11b and 11c, as needed.

In the case where the surface of the substrate 12 has no aligning power, and the adhesion between the polarized-light selective reflection layer 11-1 and the substrate 12 is satisfactorily high, it is not always required to provide the intermediate layer 13. To improve the adhesion between the polarized-light selective reflection layer 11-1 and the substrate 12, a process-related method such as corona discharge treatment or UV cleaning may also be used.

A process of producing the above-described projection screen 10-1 will be described hereinafter.

The substrate 12 to which the polarized-light selective reflection layer 11-1 will be laminated is firstly prepared. If necessary, the intermediate layer 13 such as an adherent layer is laminated to the surface of the substrate 12 on the side on which the polarized-light selective reflection layer 11-1 will be formed. The surface of the substrate 12 (the surface of the intermediate layer 13, if the intermediate layer 13 is present) to which a liquid crystalline composition will be applied is made to have no aligning power.

Thereafter, a cholesteric liquid crystalline composition is applied to the above-prepared substrate 12 and is then subjected to aligning treatment and curing treatment, whereby the polarized-light selective reflection layer 11-1 is laminated (fixed) to the substrate 12.

The steps (the steps of application, alignment and curing) for laminating (fixing) the polarized-light selective reflection layer 11-1 to the substrate 12 will be described in detail hereinafter.

(Step of Application)

In the step of application, a cholesteric liquid crystalline composition is applied to the substrate 12 to form thereon a cholesteric liquid crystal layer. Any of the known methods can be employed to apply the liquid crystalline composition to the substrate 12. Specifically, a roll, gravure, bar, slide, die, slit, or dip coating method can be used for this purpose. In the case where a plastic film is used as the substrate 12, a film coating method using a so-called roll-to-roll system may be used.

For the liquid crystalline composition that is applied to the substrate 12, a cholesteric, chiral nematic liquid crystal or a cholesteric liquid crystal may be used. Although any liquid crystalline material can be used as long as it can develop a cholesteric liquid crystalline structure, particularly preferable one for obtaining, after curing, an optically stable, polarized-light selective reflection layer 11-1 is a polymerizable liquid crystalline material having polymerizable functional groups at both ends of its molecule.

Explanation will be given below with reference to the case where a chiral nematic liquid crystal is used for the liquid crystalline composition. The chiral nematic liquid crystal is a mixture of a polymerizable, nematic liquid crystalline material and a chiral agent. The chiral agent herein refers to an agent for controlling the helical pitch in the polymerizable, nematic liquid crystalline material to make the resulting liquid crystalline composition cholesteric as a whole. To the liquid crystalline composition, a polymerization initiator and other proper additives are added.

Examples of polymerizable, nematic liquid crystalline materials include compounds represented by the following general formulae (1) and (2-i) to (2-xi). These compounds may be used either singly or in combination. 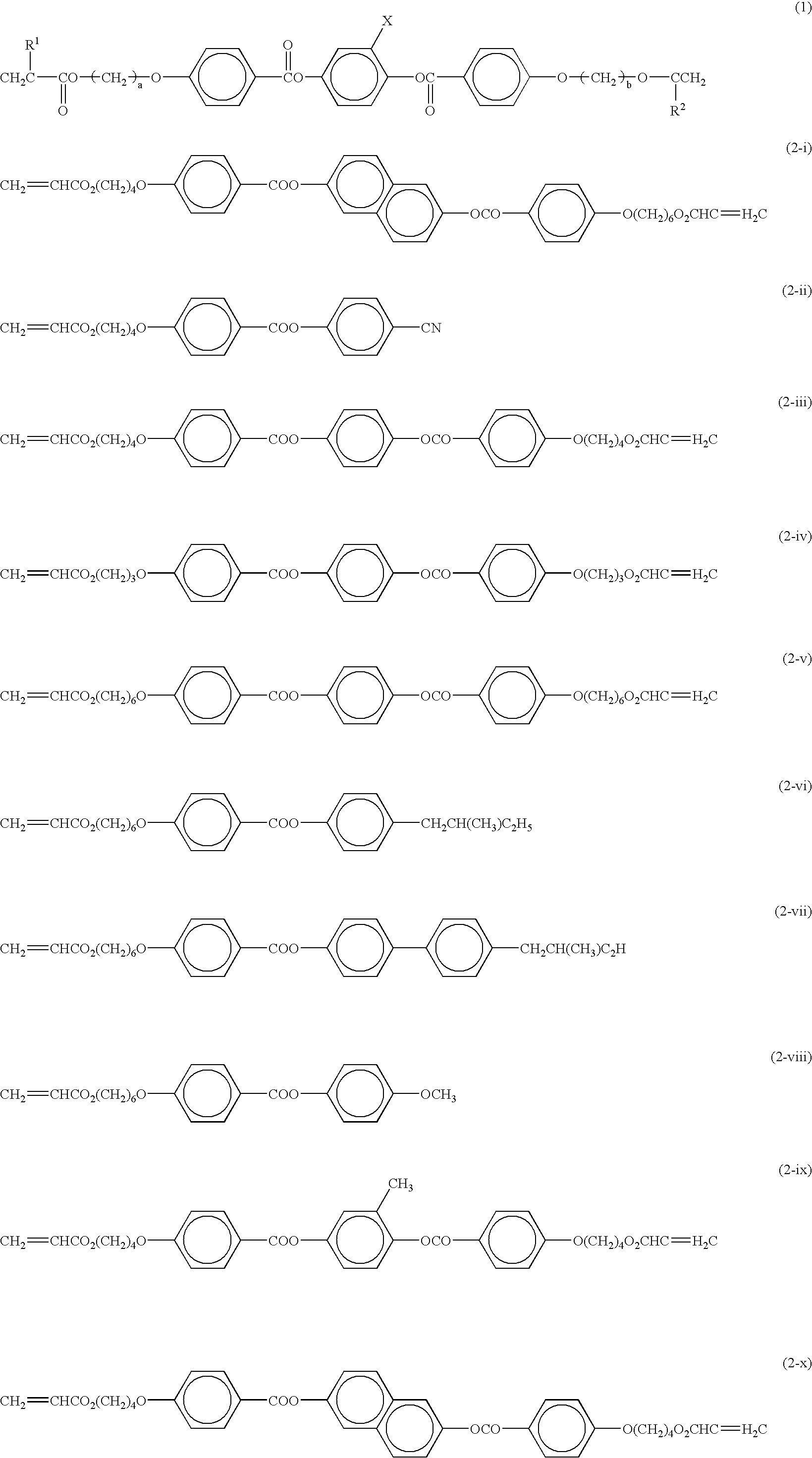 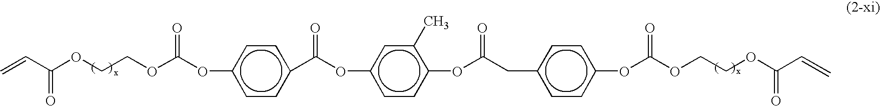
where X is an integer of 2-5.

In the above general formula (1), R¹ and R² independently represent hydrogen or methyl group. It is, however, preferable that both R¹ and R² represent hydrogen because a liquid crystalline composition containing such a compound shows a liquid crystal phase at temperatures in a wider range. X is hydrogen, chlorine, bromine, iodine, an alkyl group having 1 to 4 carbon atoms, methoxy group, cyano group or nitro group, preferably chlorine or methyl group. Further, in the above general formula (1), a and b that denote the chain lengths of the alkylene groups that serve as spacers between the (meth)acryloyloxy groups on both ends of the molecule and the aromatic rings are independently an integer of 2 to 12, preferably an integer of 4 to 10, more preferably an integer of 6 to 9. Those compounds represented by the general formula (1) in which a=b=0 are unstable, easily undergo hydrolysis, and have high crystallinity. On the other hand, those compounds represented by the general formula (1) in which a and b are independently an integer of 13 or more have low isotropic transition temperatures (TI's). Since these compounds show liquid crystal phases at temperatures in narrow ranges, they are undesirable.

Although a polymerizable liquid crystal monomer is, in the above description, used as the polymerizable, nematic liquid crystalline material, it is also possible to use, as the polymerizable, nematic liquid crystal material, a polymerizable liquid crystal oligomer or polymer, a liquid crystal polymer, or the like, properly selected from conventionally proposed ones.

On the other hand, the chiral agent is a low molecular weight compound containing an optically active site, having usually a molecular weight of not more than 1,500. The chiral agent is used in order to convert the positive mono-axially-nematic structure of a polymerizable, nematic liquid crystalline material into a helical structure. Any type of low molecular weight compounds capable of attaining the above purpose may be used as the chiral agent as long as it is compatible with the polymerizable, nematic liquid crystalline material in the state of solution or melt and can make the liquid crystalline structure helical without impairing the liquid crystallinity of the material.

The chiral agent that is used for making the structure of a liquid crystal helical is required to have any type of chirality at least in its molecule. Examples of chiral agents useful herein include those compounds having 1, or 2 or more asymmetric carbon atoms, those compounds having asymmetric centers on hetero atoms, such as chiral amines or sulfoxides, and those axially chiral compounds having optically active sites, such as cumulene and binaphthol. More specific examples of chiral agents include commercially available chiral nematic liquid crystals such as a chiral dopant liquid crystal “S-811” manufactured by Merck KGaA, Germany.

However, depending on the nature of the chiral agent selected, the following problems can occur: the nematic state of the polymerizable, nematic liquid crystalline material is destroyed, and the polymerizable, nematic liquid crystalline material loses its alignability; and, if the chiral agent is non-polymerizable, the liquid crystalline composition has reduced hardenability, and the cured film is poor in reliability. Moreover, the use of a large amount of a chiral agent having an optically active site boosts the cost of the liquid crystalline composition. Therefore, to form a polarized-light selective reflection layer having a cholesteric structure with a short helical pitch, it is preferable to select, as the optically-active-site-containing chiral agent to be incorporated in the liquid crystalline composition, a chiral agent whose helical-structure-developing action is great. Specifically, it is preferable to use one of the compounds represented by the following general formulae (3), (4) and (5), which are low-molecular-weight compounds whose molecules are axially chiral. 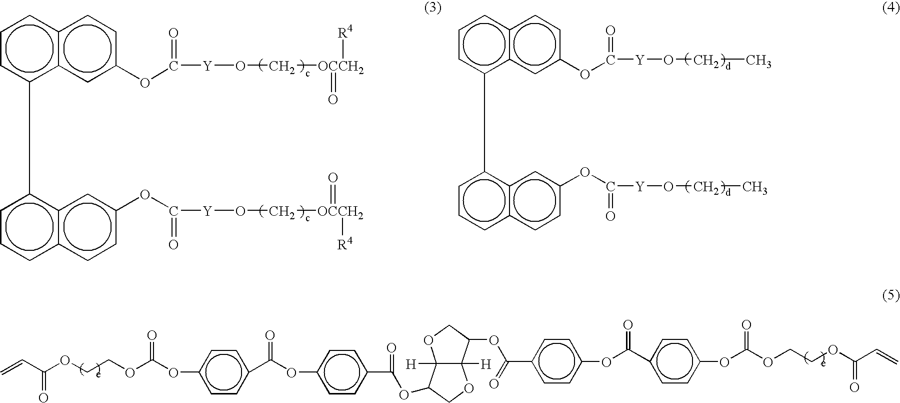
where e is an integer of 2-5

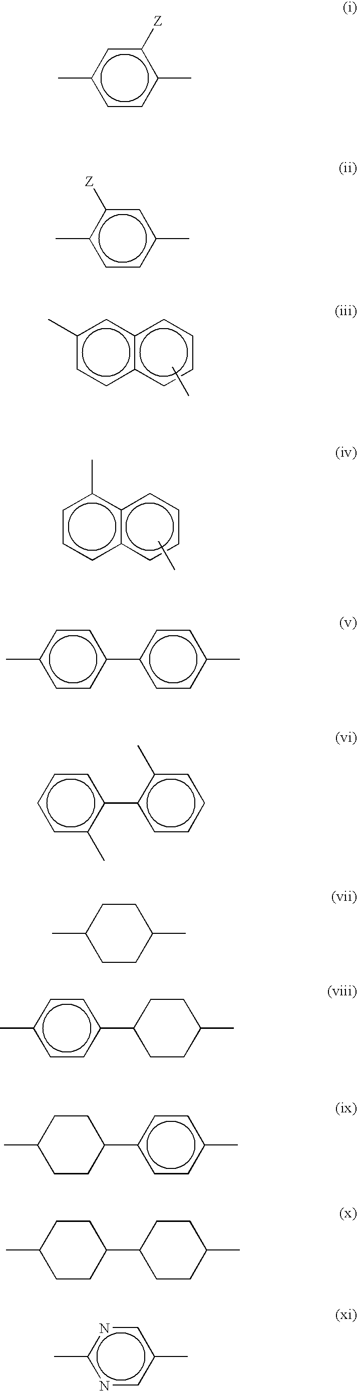

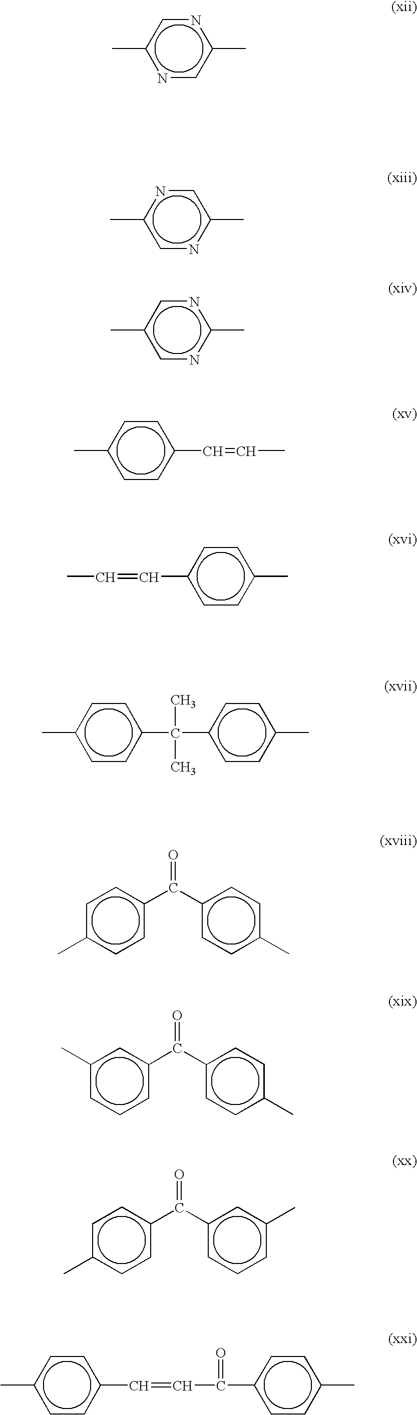

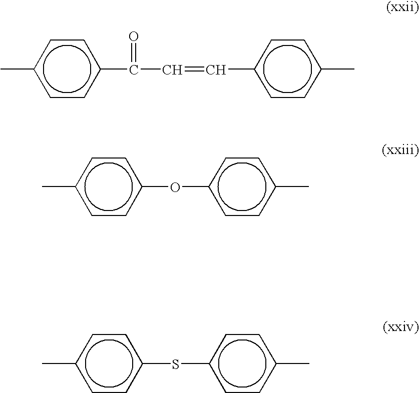

In the above general formulae (3) and (4), R⁴ represents hydrogen or methyl group; Y is one of the above-enumerated groups (i) to (xxiv), preferably (i), (ii), (iii), (v) or (vii); and c and d that denote the chain lengths of the alkylene groups are independently an integer of 2 to 12, preferably an integer of 4 to 10, more preferably an integer of 6 to 9. Those compounds represented by the above general formula (3) or (4) in which c or d is 0 or 1 are poor in stability, easily undergo hydrolysis, and have high crystallinity. On the other hand, those compounds represented by the general formula (3) or (4) in which c or d is 13 or more have low melting points (Tm's). These compounds are less compatible with the polymerizable, nematic liquid crystalline material, so that a liquid crystalline composition containing such a compound as the chiral agent may cause phase separation depending on the concentration of the compound.

The chiral agent is not necessarily polymerizable. However, if the chiral agent is polymerizable, it is polymerized with the polymerizable, nematic liquid crystalline material to give a stably fixed cholesteric structure. Therefore, from the viewpoint of thermal stability and the like, it is desirable that the chiral agent be polymerizable. In particular, the use of a chiral agent having polymerizable functional groups at both ends of its molecule is preferable to obtain a polarized-light selective reflection layer 11-1 excellent in heat resistance.

The content of the chiral agent in the liquid crystalline composition is optimally decided in consideration of the helical-structure-developing ability of the chiral agent, the cholesteric liquid crystalline structure of the resulting polarized-light selective reflection layer 11-1, and so forth. Although the amount of the chiral agent to be added greatly varies depending upon the components of the liquid crystalline composition, it is from 0.01 to 60 parts by weight, preferably from 0.1 to 40 parts by weight, more preferably from 0.5 to 30 parts by weight, most preferably from 1 to 20 parts by weight, for 100 parts by weight of the liquid crystalline composition. In the case where the amount of the chiral agent added is smaller than this range, there is a possibility that the liquid crystalline composition cannot fully become cholesteric. On the other hand, when the amount of the chiral agent added exceeds the above-described range, the alignment of liquid crystalline molecules is impeded, which can adversely affect the curing of the liquid crystalline composition that is conducted by the application of activating radiation or the like.

Although the liquid crystalline composition can be applied as it is to the substrate 12, it may be dissolved in a suitable solvent such as an organic solvent to give an ink in order to make the viscosity of the liquid crystalline composition fit for an applicator or to attain excellent alignment of liquid crystalline molecules.

Although any solvent can be used for the above purpose as long as it can dissolve the above-described polymerizable liquid crystalline material, it is preferable that the solvent does not attack the substrate 12. Specific examples of solvents useful herein include acetone, 3-methoxy-butyl acetate, diglyme, cyclohexanone, tetrahydrofuran, toluene, xylene, chlorobenzene, methylene chloride, and methyl ethyl ketone. The polymerizable liquid crystalline material may be diluted to any degree. However, considering that a liquid crystal itself is a material having low solubility and high viscosity, it is preferable to dilute the polymerizable liquid crystalline material to such a degree that the content of the liquid crystalline material in the diluted solution is in the order of preferably 5 to 50%, more preferably 10 to 30%.

(Step of Alignment)

After applying the liquid crystalline composition to the substrate 12 to form thereon a cholesteric liquid crystal layer in the above-described step of application, the cholesteric liquid crystal layer is, in the step of alignment, held at a predetermined temperature at which the cholesteric liquid crystal layer develops a cholesteric liquid crystalline structure, thereby aligning liquid crystalline molecules in the cholesteric liquid crystal layer.

The cholesteric liquid crystalline structure of the polarized-light selective reflection layer 11-1 that should be finally obtained is one not in the state of planar orientation as is shown in FIG. 2B but in such a state of orientation as is shown in FIG. 2A, in which a plurality of the helical structure parts 30 that are different in the direction of the helical axis L are present. Even so, it is necessary to conduct alignment treatment. Namely, although it is not necessary to align, in one direction on the substrate 12, the directors of liquid crystalline molecules in the cholesteric liquid crystalline structure, it is necessary to conduct such alignment treatment that a plurality of the helical-structure parts 30 are produced in the cholesteric liquid crystalline structure.

When the cholesteric liquid crystal layer formed on the substrate 12 is held at a predetermined temperature at which the cholesteric liquid crystal layer develops a cholesteric liquid crystalline structure, it shows a liquid crystal phase. At this time, owing to the self-accumulating action of liquid crystalline molecules themselves, continuous rotation of the directors of the liquid crystalline molecules occurs in the direction of the thickness of the layer, and a helical structure is produced. It is possible to fix this cholesteric liquid crystalline structure in a liquid crystal phase state by curing the cholesteric liquid crystal layer using such a technique as will be described later.

In the case where the liquid crystalline composition applied to the substrate 12 contains a solvent, the step of alignment is usually conducted along with drying treatment for removing the solvent. The drying temperature suitable for removing the solvent is from 40 to 120° C., preferably from 60 to 100° C. Any drying time (heating time) will do as long as a cholesteric liquid crystalline structure is developed and substantially all of the solvent is removed. For example, the drying time (heating time) is preferably from 15 to 600 seconds, more preferably from 30 to 180 seconds. After once conducting the drying treatment, if it is realized that the liquid crystal layer is not fully orientated, this layer may be further heated accordingly. In the case where this drying treatment is conducted by means of vacuum drying, it is preferable to separately conduct heat treatment in order to align liquid crystalline molecules.

(Step of Curing)

After aligning liquid crystalline molecules in the cholesteric liquid crystal layer in the above-described step of alignment, the cholesteric liquid crystal layer is cured in the step of curing, thereby fixing the cholesteric liquid crystalline structure that is in the liquid crystal phase state.

To effect the step of curing, it is possible to use: (1) a method in which the solvent contained in the liquid crystalline composition is evaporated; (2) a method in which liquid crystalline molecules in the liquid crystalline composition are thermally polymerized; (3) a method in which liquid crystalline molecules in the liquid crystalline composition are polymerized by the application of radiation; or (4) any combination of these methods.

Of the above methods, the method (1) is suitable for the case where a liquid crystal polymer is used as the polymerizable, nematic liquid crystalline material that is incorporated in the liquid crystalline composition for forming the cholesteric liquid crystal layer. In this method, the liquid crystal polymer is dissolved in a solvent such as an organic solvent, and this solution is applied to the substrate 12. In this case, a solidified, cholesteric liquid crystal layer can be obtained by simply removing the solvent by drying. The type of the solvent, the drying conditions, and so on are the same as those ones in the aforementioned steps of application and alignment.

The above-described method (2) is for curing the cholesteric liquid crystal layer by thermally polymerizing liquid crystalline molecules in the liquid crystalline composition by heating. In this method, the state of bonding of the liquid crystalline molecules varies according to heating (baking) temperature. Therefore, if the cholesteric liquid crystal layer is heated non-uniformly, the cured layer cannot be uniform in physical properties such as film hardness and in optical properties. In order to limit variations in film hardness to ±10%, it is preferable to control the heating temperature so that it varies only within ±5%, preferably ±2%.

Any method may be employed to heat the cholesteric liquid crystal layer formed on the substrate 12 as long as it can provide uniformity in heating temperature. The liquid crystal layer may be placed directly on a hot plate and held as it is, or placed indirectly on a hot plate with a thin air layer interposed between the liquid crystal layer and the hot plate and held parallel with the hot plate. Besides, a method using a heater capable of entirely heating a particular space, such as an oven, may be employed. In this case, the liquid crystal layer is placed in or passed through such a heater. If a film coater or the like is used, it is preferable to make the drying zone long enough to make the heating time sufficiently long.

The heating temperature required is usually as high as 100° C. or more. However, considering the heat resistance of the substrate 12, it is preferable to limit this temperature to below approximately 150° C. If a film or the like specialized with respect to heat resistance is used as the substrate 12, the heating temperature can be made as high as above 150° C.

The above-described method (3) is for curing the cholesteric liquid crystal layer by photo-polymerizing liquid crystalline molecules in the liquid crystalline composition by the application of radiation. In this method, electron beams, ultraviolet rays, or the like fitting for the conditions can be used as the radiation. In general, ultraviolet light is preferred because of the simplicity of ultraviolet light irradiation systems, and so forth. The wavelength of ultraviolet light useful herein is from 250 to 400 nm. If ultraviolet light is used, it is preferable to incorporate a photopolymerization initiator in the liquid crystalline composition in advance.

Examples of photopolymerization initiators that can be incorporated in the liquid crystalline composition include benzyl (bibenzoyl), benzoin isobutyl ether, benzoin isopropyl ether, benzophenone, benzoyl benzoic acid, benzoyl methylbenzoate, 4-benzoyl-4′-methyldiphenylsulfide, benzylmethyl ketal, dimethylamino-methyl benzoate, 2-n-butoxyethyl-4-dimethylaminobenzoate, isoamyl p-dimethylaminobenzoate, 3,3′-dimethyl-4-methoxybenzophenone, methyl-benzoyl formate, 2-methyl-1-(4-(methylthio)phenyl)-2-morpholinopropan-1-one, 2-benzyl-2-dimethylamino-1-(4-morpholinophenyl)-butan-1-one, 1-(4-dodecylphenyl)-2-hydroxy-2-methylpropan-1-one, 1-hydroxycyclo-hexyl phenyl ketone, 2-hydroxy-2-methyl-1-phenylpropan-1-one, 1-(4-isopropylphenyl)-2-hydroxy-2-methylpropan-1-one, 2-chlorothioxanthone, 2,4-diethylthioxanthone, 2,4-diisopropylthioxanthone, 2,4-dimethylthio-xanthone, isopropylthioxanthone, and 1-choloro-4-propoxythioxanthone. In addition to photopolymerization initiators, sensitizers may be added to the liquid crystalline composition unless they hinder the attainment of the object of the present invention.

The amount of the photopolymerization initiator to be added to the liquid crystalline composition is from 0.01 to 20% by weight, preferably from 0.1 to 10% by weight, more preferably from 0.5 to 5% by weight, of the liquid crystalline composition.

In this embodiment, the selective reflection wave range of the cholesteric liquid crystal layer obtained in the above-described curing step is required to have a great width Δλ.

If a cholesteric liquid crystalline composition having a birefringence value Δn of approximately 0.3 is used, the resulting cholesteric liquid crystal layer can have a selective reflection wave range with a great width Δλ regardless of the method used in the above-described curing step.

On the other hand, in the case where a cholesteric liquid crystalline composition having a birefringence value Δn of approximately 0.1 is used as a material for the cholesteric liquid crystal layer, the cholesteric liquid crystal layer is required to have a cholesteric liquid crystalline structure having helical pitches p that are continuously varied along the thickness of the layer. It is, therefore, necessary to make the helical pitch p on the observation side either shorter or longer by continuously varying, along thickness, the concentration of the chiral agent that controls the helical pitch p in a polymerizable, cholesteric liquid crystalline material.

Specifically, for example, the method described in Japanese Laid-Open Patent Publication No. 286935/2002 of our patent application may be used for the above purpose. Namely, a liquid crystalline composition such as a cholesteric liquid crystal solution containing a photopolymerization initiator is applied to the above-described substrate 12 having no aligning power, thereby forming an uncured cholesteric liquid crystal layer on the substrate 12; ultraviolet light is applied to this cholesteric liquid crystal layer with its observation side surface exposed to the atmosphere with an oxygen content of 10% or more at normal pressures; and the substrate 12 is then heated while gradually decreasing the partial pressure of oxygen in this atmosphere. In this process, the quantity of ultraviolet light that is applied to the cholesteric liquid crystal layer in the above-described atmosphere is preferably about 1 to 10% of the quantity of ultraviolet light with which the cholesteric liquid crystal layer can be cured with its helical pitch p maintained constant. In this manner, there can be obtained a cholesteric liquid crystal layer having helical pitches p that are continuously varied along thickness. Since this cholesteric liquid crystal layer have helical pitches p continuously varied along thickness, no optical interface exists within the layer.

By effecting a series of the above-described steps (steps of application, alignment and curing), it is possible to obtain a projection screen 10-1 comprising the polarized-light selective reflection layer 11-1 composed of a single cholesteric liquid crystal layer. By repeatedly conducting a series of the above-described steps, it is also possible to obtain a projection screen 10-1 comprising a polarized-light selective reflection layer 11-1 composed of a plurality of cholesteric liquid crystal layers having selective reflection wave ranges with widths Δλ increased to some extent.

In this case, as long as the underlying cholesteric liquid crystal layer has been solidified, a liquid crystalline composition for forming the second or later cholesteric liquid crystal layer can be applied by using the same technique as in the formation of the first cholesteric liquid crystal layer. Continuity is, in this case, produced between the cholesteric liquid crystalline structure (the state of orientation) of the upper cholesteric liquid crystal layer and that of the lower cholesteric liquid crystal layer. It is, therefore, unnecessary to provide an alignment-controlling layer or the like between these two cholesteric liquid crystal layers. However, an intermediate layer such as an adherent layer may be provided between these two cholesteric liquid crystal layers, as needed. In the formation of the second and later cholesteric liquid crystal layers, the conditions under which the steps of application, alignment and curing are conducted and the materials that are used for forming the cholesteric liquid crystal layers are as mentioned above, so that explanation for them is herein omitted.

Thus, the projection screen 10-1 comprises the polarized-light selective reflection layer 11-1 having a cholesteric liquid crystalline structure, adapted to selectively reflect a specific polarized-light component, and, owing to structural non-uniformity in the cholesteric liquid crystalline structure that is brought about, for example, by the helical structure parts 30 whose helical axes L extend in different direction, it diffuses light that is selectively reflected.

The polarized-light selective reflection layer 11-1 selectively reflects only a specific polarized-light component (e.g., right-handed circularly polarized light) owing to the polarized-light-separating property of the cholesteric liquid crystalline structure, so that the polarized-light selective reflection layer 11-1 can be made to reflect only approximately 50% of the unpolarized environmental light, such as sunlight and light from lighting fixtures, incident on this layer. For this reason, while maintaining the brightness of the light-indication part such as a white-indication part, it is possible to lower the brightness of the dark-indication part such as a black-indication part to nearly half, thereby obtaining nearly twice-enhanced image contrast. In this case, if the imaging light to be projected is made to mainly contain a polarized-light component that is identical with the polarized-light component which the polarized-light selective reflection layer 11-1 selectively reflects (e.g., right-handed circularly polarized light), the polarized-light selective reflection layer 11-1 can reflect nearly 100% of the imaging light projected, that is, the polarized-light selective reflection layer 11 can efficiently reflect the imaging light.

Furthermore, since the polarized-light selective reflection layer 11-1 has a structurally non-uniform, cholesteric liquid crystalline structure in which the helical structure parts 30 have helical axes L extending in different directions, this layer 11-1 reflects imaging light not by specular reflection but by diffuse reflection, and the reflected light can thus be well recognized as an image. At this time, owing to structural non-uniformity in the cholesteric liquid crystalline structure, the polarized-light selective reflection layer 11-1 diffuses light that is selectively reflected, so that it can reflect a specific polarized-light component (e.g., right-handed circularly polarized light 31R in the selective reflection wave range) while diffusing it, and, at the same time, transmits the other light components (e.g., left-handed circularly polarized light 31L in the selective reflection wave range, and right-handed circularly polarized light 32R and left-handed circularly polarized light 32L not in the selective reflection wave range) without diffusing them. For this reason, the environmental light and imaging light that pass through the polarized-light selective reflection layer 11-1 do not undergo the previously-mentioned “depolarization”, and it is thus possible to improve image visibility while maintaining the polarized-light-separating property inherent in the polarized-light selective reflection layer 11-1.

Thus, according to the above-described projection screen 10-1, it is possible to increase image contrast by suppressing the influence of environmental light such as sunlight and light from lighting fixtures by making use of the polarized-light-separating property of the cholesteric liquid crystal structure, and, at the same time, by making use of structural non-uniformity in the cholesteric liquid crystalline structure, it is possible to diffuse the imaging light that is reflected, without lowering image visibility. The projection screen 10-1 can, therefore, sharply display an image even under bright environmental light. Moreover, since the polarized-light selective reflection layer 11-1 that diffuse-reflects a specific-polarized light component has substantially the same reflectance for light in a wave range of at least 450 to 650 nm, even when environmental light obliquely enters the polarized-light selective reflection layer 11-1, this environmental light does not disturb the balance of intensity among the imaging light reflected from the polarized-light selective reflection layer 11-1, and the intensities of the reflected light in the wave ranges for red (R), green (G) and blue (B) colors remain balanced (a good white balance is maintained). Improved image visibility can thus be obtained.

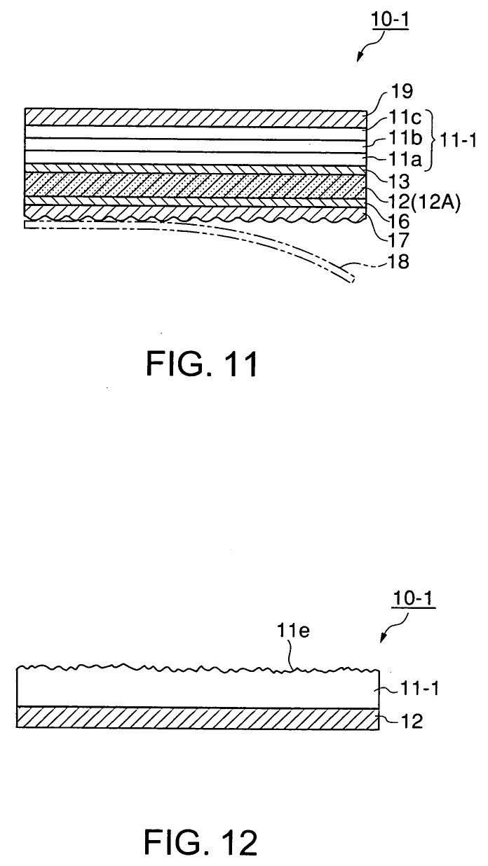

In the above-described projection screen 10-1, a light-reflecting layer 16 for reflecting light incident on the substrate 12 may be provided on the surface of the substrate 12 opposite to the side on which the polarized-light selective reflection layer 11-1 is provided, as shown in FIG. 11. When a light-reflecting layer 16 is provided on the substrate 12 that contains a light-absorbing layer in the manners shown in FIGS. 6 to 8, environmental light, such as sunlight and light from lighting fixtures, incident on the back surface of the projection screen 10-1 can be effectively reflected from this surface before reaching the substrate 12 (especially, the light-absorbing layer contained in the substrate 12). It is, therefore, possible to effectively prevent the substrate 12 from generating heat. Preferable examples of materials for the light-reflecting layer 16 include white-colored scattering layers (paper, white-colored films, coatings, etc.), metallic plates, and aluminum powder films.

Further, as shown in FIG. 11, a pressure-sensitive adhesive layer 17 useful for affixing, to an external member, the substrate 12 on which the polarized-light selective reflection layer 11-1 is formed may be provided on the substrate 12 opposite to the side on which the polarized-light selective reflection layer 11-1 is provided (on the backside of the light-reflecting layer 16 in FIG. 11). If a pressure-sensitive adhesive layer 17 is so provided, the projection screen 10-1 can be affixed to an external member such as a white board or wall, if necessary. The pressure-sensitive adhesive layer 17 is preferably a layer that can separably adhere, to an external member, the substrate 12 on which the polarized-light selective reflection layer 11-1 is formed. It is, therefore, preferable to use, as the pressure-sensitive adhesive layer 17, a pressure-sensitive adhesive film with slight tackiness such as a releasable, pressure-sensitive adhesive film (manufactured by Panack Co., Ltd., Japan). Moreover, it is preferable to cover the surface of the pressure-sensitive adhesive layer 17 with a releasing film 18 in order to protect the pressure-sensitive adhesive layer 17 before use.

Furthermore, as shown in FIG. 11, a functional layer 19 may be provided on the observation side surface of the polarized-light selective reflection layer 11-1. A variety of layers including a hard coat (HC) layer, an anti-glaring (AG) layer, an anti-reflection (AR) layer, an ultraviolet-light-absorbing (UV-absorbing) layers, and an antistatic (AS) layer can be used as the functional layer 19.

The hard coat (HC) layer is for protecting the surface of the projection screen 10-1 and preventing it from being scratched or staining. The anti-glaring (AG) layer is for preventing the projection screen 10-1 from glaring. The anti-reflection (AR) layer is for preventing the surface of the projection screen 10-1 from reflecting light. The ultraviolet-light-absorbing (UV-absorbing) layer is for absorbing the ultraviolet light component of light incident on the projection screen 10-1, the UV component causing yellowing of the liquid crystalline composition. The antistatic (AS) layer is for removing static electricity that is generated in the projection screen 10-1. In the case where the antistatic layer is used as the functional layer 19, this layer is not always provided on the observation side surface of the polarized-light selective reflection layer 11-1, and may be provided on the back surface of the substrate 12. Moreover, carbon particles or the like may be incorporated in the substrate 12, thereby imparting, to the substrate 12 itself, the property of removing static electricity.

In general, the functional layer 19 serving as an anti-glaring layer has the property of preventing the surface of the projection screen 10-1 from mirroring viewers and their surroundings, and is significant for clear image recognition. A transparent layer with a roughened surface is preferably used as the anti-glaring layer, and by the use of such a layer, it is possible to effectively prevent mirroring of objects that occurs on the surface of the projection screen 10-1 because of interfacial reflection. Such a transparent layer can be obtained by roughening the surface of a transparent resin, glass, or the like by such a method as sandblasting, transfer of the shape of a molding surface, or chemical treatment. The surface of a transparent layer may be roughened either irregularly or regularly. To maintain the polarized-light-separating property of the polarized-light selective reflection layer 11-1, it is preferable that the anti-glaring layer be isotropic with respect to refractive index. Examples of materials useful for the anti-glaring layer include glass, resins such as acrylic resins and polyester resins, and TAC (triacetyl cellulose) films with matte surfaces.

Instead of providing, separately from the polarized-light selective reflection layer 11-1, the functional layer 19 serving as an anti-glaring layer, as shown in FIG. 11, thereby imparting the anti-glaring property to the projection screen 10-1, the observation side surface of the polarized-light selective reflection layer 11-1 may be roughened (see reference numeral 11e), as shown in FIG. 12, thereby imparting the anti-glaring property to the polarized-light selective reflection layer 11-1 itself.

The aforementioned projection screen 10-1 comprises the polarized-light selective reflection layer 11-1 having a cholesteric liquid crystalline structure not in the state of planar orientation, in which the helical axes L extend in different directions, as shown in FIG. 2A. Instead of such a polarized-light selective reflection layer, the projection screen 10-1 may comprise a polarized-light selective reflection layer composed of partial selective reflection layers having any structure.

Specifically, for example, the polarized-light selective reflection layer 11-1 may comprise a polarized-light selective reflection layer body that selectively reflects a specific polarized-light component (e.g., a polarized-light selective reflection layer composed of a plurality of partial selective reflection layers having such a cholesteric liquid crystalline structure in the state of planar orientation as is shown in FIG. 2B, causing specular reflection) and a diffusing element that diffuses the light reflected from the polarized-light selective reflection layer body. By so constituting the polarized-light selective reflection layer 11-1, it is possible to make the polarized-light-separating property and diffusing properties independent of each other, and is thus possible to easily control these two properties. The diffusing element may be any one of bulk diffusers, surface diffusers and hologram diffusers, or any combination of these diffusers. A bulk diffuser may be particles dispersed in a transparent medium, for example. A surface diffuser may be a structured, micro-structured, or roughened surface, for example. The diffusion provided by the diffuser may be random, regular, or partly regular.

The polarized-light selective reflection layer 11-1 may also be a layer that diffuse-reflects, as the specific polarized-light component, linearly polarized light. Linearly polarized light includes light in two different states of polarization, the directions of vibration being at right angles to each other. Therefore, by making the direction of linear polarization of light to be emitted from a projector agree with the direction of linear polarization of light which this layer diffuse-reflects, it is possible to brightly display an image. Further, for example, a multi-layered reflective polarizer having diffusing properties, made from materials different in refractive index (e.g., DBEF manufactured by Sumitomo 3M Limited, Japan), can be employed as the layer that diffuse-reflects linearly polarized light as the specific polarized-light component. Linearly polarized light is composed of so-called P-polarized light (a component parallel to the plane of incidence) and S-polarized light (a component perpendicular to the plane of incidence). Therefore, when the layer that diffuse-reflects linearly polarized light diffuse-reflects only a specific polarized-light component (e.g., P- or S-polarized light), it can increase image contrast like the above-described polarized-light selective reflection layer 11-1. Further, this layer can effectively reflect imaging light if the imaging light to be projected on the layer is made to mainly contain P- or S-polarized light.

Although the above embodiment is described by referring to the case where the substrate 12, a component of the projection screen 10-1, is an absorptive substrate containing a light-absorbing layer that absorbs light in the visible region, the substrate 12 may also be a transparent substrate adapted to transmit at least part of light in the visible region. If a transparent substrate is used, although the advantage of enhancing image contrast is lost, the projection screen 10-1 is highly transparent when not displaying an image, and the background can thus be clearly seen through the projection screen 10-1. Therefore, the projection screen 10-1 can be conveniently used in decorative applications; for example, it is fit for use on a show window. Moreover, by switching the viewing angle according to the situation, it is possible to produce a more effective eye-catching effect. For this reason, the projection screen 10-1 can overcome the drawback of conventional information tools using projectors that they are not attractive in a bright environment, and can effectively be used in such applications as billboards, bulletin boards, and guideboards. Although the transparent substrate is preferably less hazy, any material selected from acrylic resins, glass, vinyl chloride resins, etc. may be used for the substrate as long as it can transmit light. Further, the transparent substrate is not necessarily colorless, and a colored one may also be used. Specifically, it is possible to use transparent plastic or glass plates in a color of brown, blue, orange, or the like that are usually used for partition walls, windows, and so forth.

Further, in the projection screen 10-1, an intermediate layer having adhesion properties (an adherent layer) may be provided between the polarized-light selective reflection layer 11-1 and the substrate 12, or between each neighboring two of the partial selective reflection layers constituting the polarized-light selective reflection layer 11-1. The intermediate layer may have barrier properties in addition to (or in place of) the adhesion properties. The barrier properties herein mean the following action: when a polarized-light selective reflection layer is laminated directly to a substrate, or when one partial selective reflection layer is laminated directly to another partial selective reflection layer, the constituents of the lower layer are prevented from migrating to (permeating through) the upper layer, or the constituents of the upper layer are prevented from migrating to (permeating through) the lower layer. If substances migrate between the upper and lower layers, the optical properties (wavelength selectivity, polarization selectivity, diffusing properties, etc.) inherent in the polarized-light selective reflection layer (or each partial selective reflection layer) that is the upper or lower layer are impaired. However, this can be prevented by the use of the above-described intermediate layer having barrier properties (barrier layer). Specifically, for example, in the case where a partial selective reflection layer is laminated to another partial selective reflection layer by applying a cholesteric liquid crystalline composition, a nematic liquid crystal component contained in the liquid crystalline composition for forming the upper partial selective reflection layer may permeate through the lower partial selective reflection layer to change (increase) the helical pitch in the lower partial selective reflection layer, depending upon the materials of the liquid crystalline composition, the process conditions, and the like. However, even in this case, if a barrier layer is provided between the lower and upper partial selective reflection layers, the migration (permeation) of the nematic liquid crystal component does not occur, and the optical properties (wavelength selectivity, polarization selectivity, diffusing properties, etc.) of the partial selective reflection layers are successively maintained.

Examples of materials that can be used for forming such a barrier layer include modified acrylates, urethane acrylates, polyester acrylates, and epoxy resins. These compounds may be either monofunctional or polyfunctional and include monomers and oligomers. Specific examples of these compounds include ethoxylated trimethylolpropane triacrylate, propoxylated glyceryl triacrylate, pentaerythritol tetraacrylate, ditrimethylolpropane tetraacrylate, dipentaerythritol hydroxypentaacrylate, ethoxylated pentaerythritol tetraacrylate, pentaacrylic ester, pentaerythritol triacrylate, trimethylolpropane triacrylate, trimethylolpropane PO-modified triacrylate, isocyanuric acid EO-modified triacrylate, trimethylolpropane EO-modified triacrylate, dipentaerythritol penta- or hexa-acrylate, urethane adducts, aliphatic polyamine epoxy resins, polyaminoamide epoxy resins, aromatic diamine epoxy resins, alicyclic diamine epoxy resins, phenolic epoxy resins, amino epoxy resins, mercaptan epoxy resins, dicyandiamide epoxy resins, and Lewis acid complex epoxy resins.

Another Embodiment

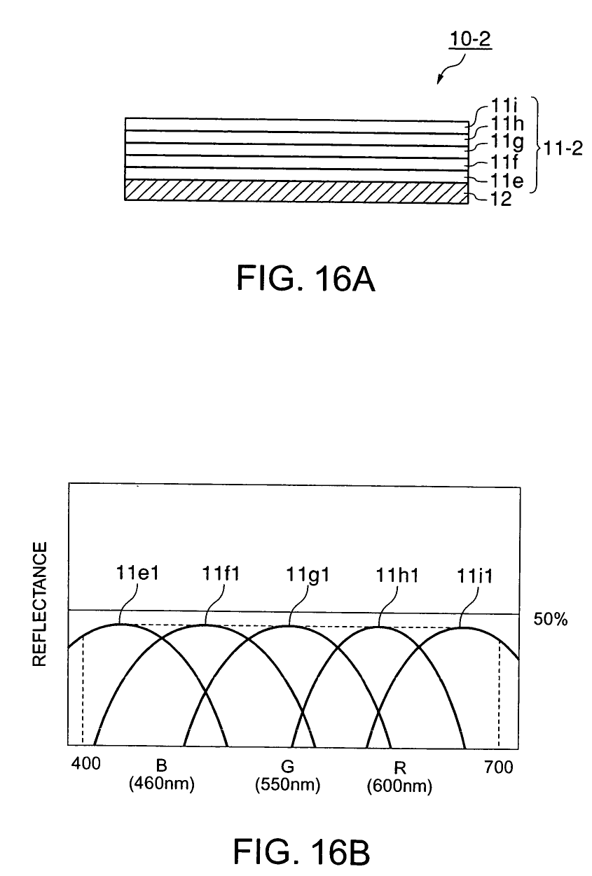

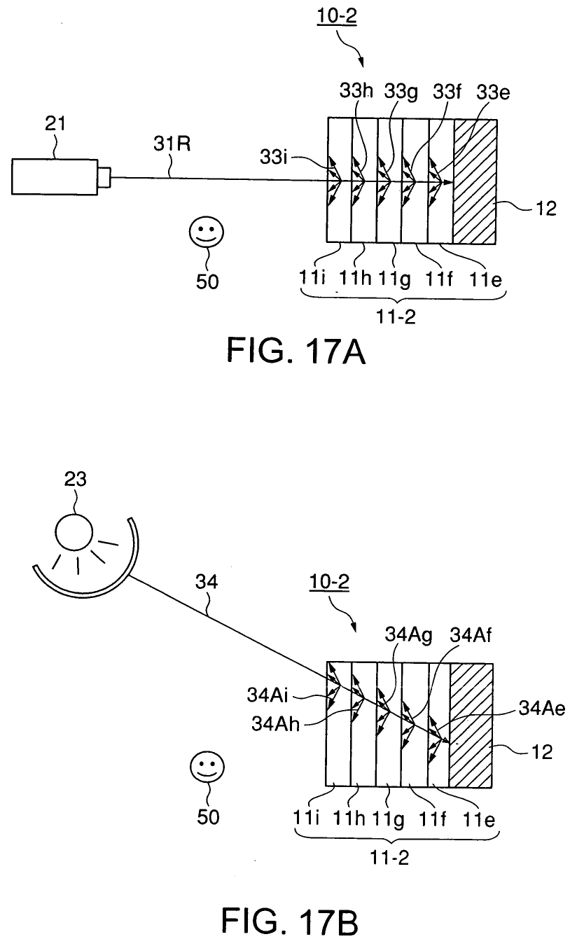

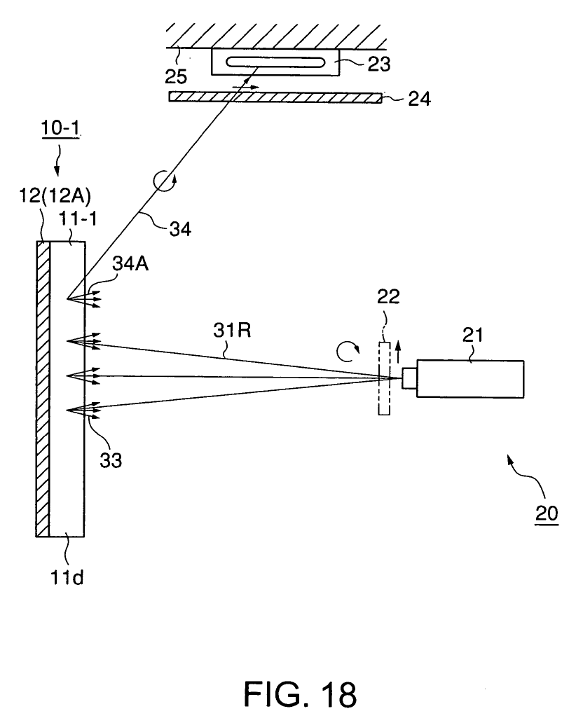

A projection screen according to another embodiment of the present invention will now be described with reference to FIGS. 16A, 16B, 17A and 17B. The projection screen shown in these figures is almost the same as the projection screen shown in FIGS. 1 to 13B, except that the polarized-light selective reflection layer is composed of a plurality of partial selective reflection layers having selective reflection wave ranges whose widths Δλ are not great. Throughout FIGS. 16A to 17B and FIGS. 1 to 13B, identical parts are denoted by like reference numerals, and those component parts of the projection screen shown in FIGS. 16A to 17B that are identical with the above-described component parts of the projection screen shown in FIG. 1 to 13B will not be explained any more.

As shown in FIG. 16A, a projection screen 10-2 comprises a polarized-light selective reflection layer 11-2 composed of five partial selective reflection layers 11e-11i having selective reflection wave ranges whose widths Δλ are not so great.

As shown in FIG. 16B, these partial selective reflection layers 11e-11i have different reflection wave ranges 11e1-11i1. Since these reflection wave ranges 11e1-11i1 continuously overlap one another, the polarized-light selective reflection layer 11-2 has substantially the same reflectance (see the broken line in FIG. 16B) for light in a predetermined wide wave range (e.g., in the wave range of 400 to 700 nm). FIG. 16B plots wavelength (λ) as the abscissa and reflectance (R) as the ordinate.

Namely, the polarized-light selective reflection layer 11-2 is composed of the partial selective reflection layer 11e that selectively reflects light in the wave range 11e1 on the shorter wavelength side (e.g., in the vicinity of 420 nm), the partial selective reflection layer 11f that selectively reflects light in the wave range 11f1 (e.g., in the vicinity of 470 nm), the partial selective reflection layer 11g that selectively reflects light in the wave range 11f1 (e.g., in the vicinity of 540 nm), the partial selective reflection layer 11h that selectively reflects light in the wave range 11h1 (e.g., in the vicinity of 600 nm), and the partial selective reflection layer 11i that selectively reflects light in the wave range 11i1 on the longer wavelength side (e.g., in the vicinity of 670 nm), which are successively laminated to the substrate 12 in this order. These partial selective reflection layers 11e-11i may be laminated in any other order as long as the resulting polarized-light selective reflection layer 11-2 has a wide reflection wave range and has substantially the same reflectance (approximately 50%) for light in a wave range of at least 450 to 650 nm.

Each one of the partial selective reflection layers 11e-11i constituting the polarized-light selective reflection layer 11-2 has a cholesteric liquid crystalline structure adapted to selectively reflect a specific-polarized light component (e.g., right-handed polarized light component), and owing to structural non-uniformity in the cholesteric liquid crystalline structure, diffuses light that is selectively reflected, like the polarized-light selective reflection layer 11-1 shown in FIGS. 1 and 2A. Further, it is possible to control the reflection wave range (the center wavelength of the selective reflection wave range) of each partial selective reflection layer by varying the chiral power by changing the type of the chiral agent to be added to a liquid crystalline composition for forming the partial selective reflection layer, or by varying the chiral agent content of the liquid crystalline composition.

The reflection wave range of such a polarized-light selective reflection layer 11-2 covers the wave ranges of imaging light projected from a projector (the wave ranges for the three primary colors of light, that is, red (R) (peak wavelength: 600 nm), green (G) (peak wavelength: 550 nm) and blue (B) (peak wavelength: 460 nm)). Moreover, in such a polarized-light selective reflection layer 11-2, the blue shift phenomenon does not occur because the imaging light enters the polarized-light selective reflection layer 11-2 from the front. Therefore, the intensity of the imaging light projected from the projector becomes equal to the intensity of the imaging light reflected from the polarized-light selective reflection layer 11-2, and the original colors of the imaging light in the wave ranges for red (R), green (G) and blue (B) colors, the three primary colors of light, can thus be successfully reproduced. Further, since the polarized-light selective reflection layer 11-2 has substantially the same reflectance for light in a wave range of 450 to 650 nm, even when the selective reflection wave range of the polarized-light selective reflection layer 11-2 shifts to the shorter wavelength side, that is, the so-called blue shift phenomenon occurs, the intensity of environmental light in a wave range of at least 450 to 650 nm (in a wave range including the wave ranges for red (R), green (G) and blue (B) colors, the three primary colors of light) reflected from the polarized-light selective reflection layer 11-2 can be maintained approximately uniform. For this reason, the color of achromatic environmental light emitted from an illuminant, such as sunlight and light from lighting fixtures, can be successfully reproduced, and it is thus possible to prevent coloring of the environmental light that is realized when an image containing a white or black part is produced (e.g., a white part appears reddish white, and a black part, reddish gray). Therefore, even when environmental light obliquely enters the polarized-light selective reflection layer 11-2, this environmental light does not disturb the balance of intensity among the imaging light reflected from the polarized-light selective reflection layer 11-2, and the intensities of the reflected light in the wave ranges for red (R), green (G), and blue (B) colors remain balanced (a good white balance is maintained). Namely, it is possible to prevent the color of the polarized-light selective reflection layer 11-2 (the color of the foundation of the projection screen 10-2) from becoming blue, reddish purple, or the like, thereby increasing image visibility.

The optical function of the projection screen 10-2 comprising the polarized-light selective reflection layer 11-2 of the above-described construction will be described with reference to FIGS. 17A and 17B.

As shown in FIG. 17A, a projector 21 is placed on the observation side (the side on which a viewer 50 makes observation) of the projection screen 10-2, around the normal to the center portion of the projection screen 10-2. Imaging light (right-handed circularly polarized light 31R in the selective reflection wave range) projected from the projector 21 enters the projection screen 10-2 from the front. In this case, the imaging light projected from the projector 21 is right-handed circularly polarized light 31R in the selective reflection wave range which the partial selective reflection layers 11e-11i constituting the polarized-light selective reflection layer 11-2 in the projection screen 10-2 reflect. Therefore, the diffuse-reflection of this imaging light occurs inside the partial selective reflection layers 11e-11i owing to the polarized-light-separating property, wavelength selectivity and scattering property of the cholesteric liquid crystalline structures of the partial selective reflection layers 11e-11i constituting the polarized-light selective reflection layer 11-2. As a result, reflected light 33e-33i are produced.

As mentioned above, since the polarized-light selective reflection layer 11-2 has substantially the same reflectance (approximately 50%) for light in a wave range of 400 to 700 nm, this layer 11-2 can reflect light while substantially maintaining the wavelength-dependent dispersion of the light as long as the wavelength of the light falls in a wave range of 400 to 700 nm. The reflection wave range of such a polarized-light selective reflection layer 11-2 covers the wave ranges of the imaging light projected from the projector (the wave ranges for red (R), green (G) and blue (B) colors, the three primary colors of light). Moreover, in such a polarized-light selective reflection layer 11-2, the blue shift phenomenon does not occur because the imaging light (right-handed circularly polarized light 31R in the selective reflection wave range) enters the polarized-light selective reflection layer 11-2 from the front. Therefore, the intensity of the imaging light (right-handed circularly polarized light 31R in the selective reflection wave range) projected from the projector 21 becomes equal to the intensity of the imaging light reflected from the polarized-light selective reflection layer 11-2 (the intensity of the reflected light 33e-33i). The original colors of the imaging light in the wave ranges for red (R), green (G), and blue (B) colors can thus be successfully reproduced.

On the other hand, an illuminant 23 is, as shown in FIG. 17B, set on the observation side (the side on which a viewer 50 makes observation) of and diagonally above the projection screen 10-2, where light 34 emitted from the illuminant 23 obliquely enters the projection screen 10-2. The light 34 emitted from the illuminant 23 (a lighting fixture emitting unpolarized light, such as a fluorescent lamp) is, for example, unpolarized, achromatic light (light in a wide wave range of, for example, 450 to 650 nm), so that the diffuse-reflection of this light 34 occurs inside the partial selective reflection layers 11e-11i constituting the polarized-light selective reflection layer 11-2 owing to the polarized-light-separating property, wavelength selectivity and scattering property of the cholesteric liquid crystalline structures of the partial selective reflection layers 11e-11i. As a result, reflected light 34Ae-34Ai are produced.

As mentioned above, since the polarized-light selective reflection layer 11-2 has substantially the same reflectance (approximately 50%) for light in a wave range of 400 to 700 nm, even when the selective reflection wave range of the polarized-light selective reflection layer 11-2 shifts to the shorter wavelength side, that is, the so-called blue shift phenomenon occurs, the intensity of environmental light in a wave range of at least 450 to 650 nm (in a wave range including the wave ranges for red (R), green (G) and blue (B) colors, the three primary colors of light) reflected from the polarized-light selective reflection layer 11-2 can be kept approximately uniform. For this reason, the original color of the achromatic light 34 emitted from the illuminant 23 can be successfully reproduced, and it is thus possible to prevent coloring of the light 34 that is realized when an image including a white or black part is produced (e.g., a white part appears reddish white, and a black part, reddish gray). Therefore, even when the light 34 emitted from the illuminant 23 obliquely enters the polarized-light selective reflection layer 11-2, this light 34 does not disturb the balance of intensity among the imaging light (right-handed circularly polarized light 31R in the selective reflection wave range), and the intensities of the reflected light in the wave ranges for red (R), green (G) and blue (B) colors remain balanced (a good white balance is maintained). Namely, it is possible to prevent the color of the polarized-light selective reflection layer 11-2 (the color of the foundation of the projection screen 10-2) from becoming blue, reddish purple, or the like, thereby enhancing image visibility.

The intensity of the imaging light (right-handed circularly polarized light 31R in the selective reflection wave range) reflected from the polarized-light selective reflection layer 11-2 (the intensity of the reflected light 33e-33i) is determined by the reflected light 33e-33i and the light passing through the substrate 12 (see the broken line in FIG. 13A). Similarly, the intensity of the light 34 reflected from the polarized-light selective reflection layer 11-2 (the intensity of the reflected light 34Ae-34Ai) is determined by the reflected light 34Ae-34Ai and the light passing through the substrate 12 (see the broken line in FIG. 13B).

Projection System

The above-described projection screens 10-1 and 10-2 can be incorporated into a projection system 20 comprising a projector 21, as shown in FIG. 18. Although explanation will now be given by referring to the projection system 20 comprising the projection screen 10-1, the basic construction and actions of a projection system comprising the projection screen 10-2 are the same as those of the projection system 20 comprising the projection screen 10-1.

As shown in FIG. 18, the projection system 20 comprises the projection screen 10-1 and the projector 21 that projects imaging light on the projection screen 10-1.

Of these components, the projector 21 may be of any type, and a CRT projector, a liquid crystal projector, a DLP (digital light processing) projector, or the like can be used. It is, however, preferable that the imaging light to be projected on the projection screen 10-1 from the projector 21 chiefly contains a polarized-light component (e.g., right-handed circularly polarized light) that is identical with the polarized-light component which the projection screen 10-1 selectively reflects.

Because of its operating principle, a liquid crystal projector useful as the projector 21 usually emits light that is polarized substantially linearly. In this case, by letting the imaging light emerge from the projector 21 through a retardation layer 22 or the like, it is possible to convert the linearly polarized light into circularly polarized light without causing the loss of the amount of light.

A quarter wave plate is preferably used as the retardation layer 22. Specifically, an ideal retardation layer is one capable of causing a phase shift of 137.5 nm for light of 550 nm whose visibility is highest. Further, a wide-wave-range quarter wave plate is more preferable because it is applicable to light in all of the red (R), green (G) and blue (B) color wave ranges. It is also possible to use a single retardation layer produced by controlling the birefringence of a material for this layer, or a retardation layer using a quarter wave plate in combination with a half wave plate.

The retardation layer 22 may be externally attached to the exit aperture of the projector 21, as shown in FIG. 18, or internally placed in the projector 21.

When a CRT or DLP projector is used as the projector 21, since the projector 21 emits unpolarized light, it is necessary to use a circular polarizer composed of a linear polarizer and a retardation layer in order to convert the unpolarized light into circularly polarized light. If such a circular polarizer is used, although the amount of light emitted from the projector 21 itself is decreased to half, it is possible to effectively prevent the production of stray light or the like from a polarized-light component (e.g., left-handed circularly polarized light) that is different from the polarized-light component which the polarized-light selective reflection layer 11-1 in the projection screen 10-1 selectively reflects, thereby enhancing image contrast. In the case where linearly polarized light is produced by an optical system incorporated in the projector 21, only a retardation layer may be used without using a linear polarizer.

A projector 21 usually attains color display using light in the wave ranges for red (R), green (G) and blue (B) colors, the three primary colors of light. For example, assuming that light enters the projection screen 10-1 vertically to it, the projector 21 is made to project light in wave ranges with center wavelength of 430-460 nm, 540-570 nm, and 580-620 nm.

The projection system 20 usually comprises an illuminant 23 that is fixed to an illuminant-fixing member 25 such as the ceiling of a room, and this illuminant 23 illuminates a space in which the projection screen 10-1 is placed.

As shown in FIG. 18, in the case where the illuminant 23 is so positioned that the light 34 emitted from the illuminant 23 directly illuminates the projection screen 10-1, it is preferable to make the light 34 to be emitted from the illuminant 23 toward the projection screen 10-1 mainly contain a polarized-light component (e.g., left-handed circularly polarized light) that is different from the polarized-light component which the projection screen 10-1 selectively reflects. By so making the light 34, it is possible to effectively prevent the light 34 from being reflected from the polarized-light selective reflection layer 11-1 in the projection screen 10-1, thereby enhancing image contrast.

It is possible to control the state of polarization of the light 34 that is emitted from the illuminant 23, by providing, in the vicinity of the illuminant 23, a polarizer film 24 adapted to transmit left-handed circularly polarized light. An absorption circular polarizer or a polarized-light separator (reflection circular polarizer) may be used as the polarizer film 24. Examples of polarized-light separators useful herein include circularly-polarized-light separators using cholesteric liquid crystal layers, and linearly-polarized-light separators containing, on the exit side, retardation layers for converting linearly polarized light into circularly polarized light. These polarized-light separators are superior to absorption circular polarizers because they cause smaller loss of the amount of light than absorption circular polarizers do.

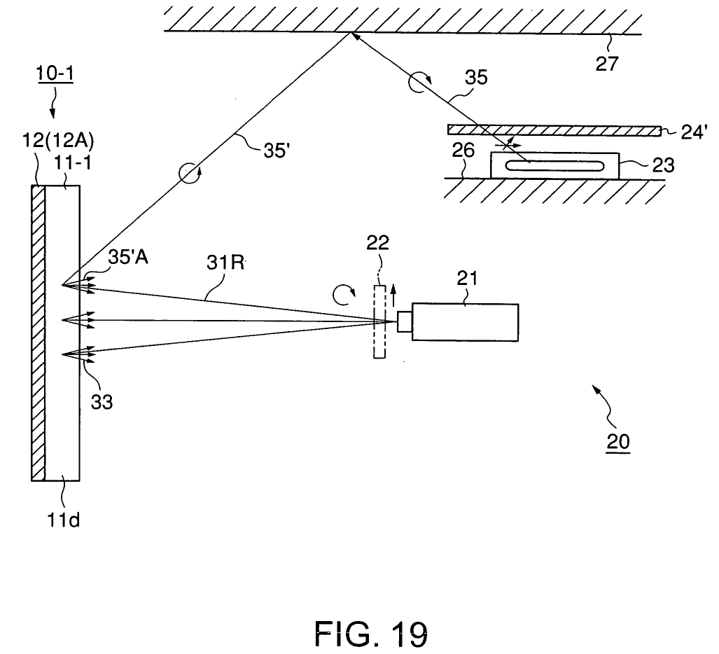

In the projection system 20 shown in FIG. 18, the light 34 emitted from the illuminant 23 directly illuminates the projection screen 10-1. The present invention is not limited to this, and also includes an embodiment in which the illuminant 23 is, as shown in FIG. 19, fixed on an illuminant-fixing member 26 other than the ceiling so that the light 35 emitted from the illuminant 23 indirectly illuminates, as light 35′, the projection screen 10-1 via a reflector 27 such as the ceiling. In this case, the state of polarization of the circularly polarized light is reversed when the reflector 27 reflects the light. It is, therefore, preferable to make the light 35 to be emitted from the illuminant 23 toward the reflector 27 mainly contain a polarized-light component (e.g., right-handed circularly polarized light) that is identical with the polarized-light component which the projection screen 10-1 selectively reflects, by providing a polarizer film 24′ or the like that transmits right-handed circularly polarized light, as in the case shown in FIG. 18. The polarizer film 24′ may be the same as the above-described polarizer film 24. If such a polarizer film is used, the light 35′ whose state of polarization has been reversed by the reflector 27 is to mainly contain a polarized-light component (e.g., left-handed circularly polarized light) that is different from the polarized-light component which the projection screen 10-1 selectively reflects. For this reason, it is possible to effectively prevent the light 35′ from being reflected from the polarized-light selective reflection layer 11-1 in the projection screen 10-1, thereby enhancing image contrast.

In the projection screen 10-1 shown in FIGS. 18 and 19, the polarized-light selective reflection layer 11-1 has substantially the same reflectance for light in a wave range of at least 450 to 650 nm. Therefore, if the light 34, 35′ emitted from the illuminant 23 is achromatic, the light 34A, 35′A that is reflected from the polarized-light selective reflection layer 11-1 is also achromatic. For this reason, to control of the state of polarization of the light 34, 35′ is required not to prevent coloring of the light 34, 35′ that occurs because of the blue shift phenomenon, but only to improve image contrast.

Further, in the projection screen 10-1 shown in FIGS. 18 and 19, since the polarized-light selective reflection layer 11-1 has substantially the same reflectance for light in a wave range of at least 450 to 650 nm, the intensity of the light 34, 35′ reflected from the polarized-light selective reflection layer 11-1 (reference numerals 34A, 35′A) (the intensity of the reflected light in a wave range including the wave ranges for red (R), green (G) and blue (B) colors, the three primary colors of light) can be maintained approximately uniform. Therefore, the original color of the achromatic light 34, 35′ emitted from the illuminant 23 can be successfully reproduced, and it is thus possible to prevent coloring of this light that is realized when an image including a white or black part is produced (e.g., a white part appears reddish white, and a black part, reddish gray). For this reason, the environmental light 34, 35′ obliquely entering the polarized-light selective reflection layer 11-1 does not disturb the balance of intensity among the imaging light 31R reflected from the polarized-light selective reflection layer 11-1 (i.e., the reflected light 33), and the intensities of the reflected light in the wave ranges for red (R), green (G) and blue (B) colors remain balanced (a good white balance is maintained). Namely, it is possible to prevent the color of the polarized-light selective reflection layer 11-1 (the color of the foundation of the projection screen 10-1) from becoming blue, reddish purple, or the like, thereby enhancing image visibility.

### EXAMPLES

A specific example of the above-described embodiments will now be given below.

(Example)

A first cholesteric liquid crystal solution having a selective reflection wave range with a center wavelength of 670 nm was prepared by dissolving, in cyclohexanone, a monomer-containing liquid crystal consisting of a main component that was an ultraviolet-curing, nematic liquid crystal (94.7% by weight) and a polymerizable chiral agent (5.3% by weight). A liquid crystal containing a compound represented by the above chemical formula (2-xi) was used as the nematic liquid crystal. A compound represented by the above chemical formula (5) was used as the polymerizable chiral agent. To the first cholesteric liquid crystal solution was added 5% by weight of a photopolymerization initiator available from Ciba Specialty Chemicals K.K., Japan.

By a bar coating method, the above-prepared first cholesteric liquid crystal solution was applied to a substrate, a 1200 mm×900 mm black-colored PET film coated with an adherent layer (Lumirror/AC-X manufactured by Panack Co., Ltd., Japan).

This substrate was heated in an oven at 80° C. for 90 seconds, thereby conducting aligning treatment (drying treatment). Thus, a cholesteric liquid crystal layer containing no solvent was obtained.

Thereafter, 50 mW/cm² of ultraviolet light with a wavelength of 365 nm was applied to this cholesteric liquid crystal layer for 1 minute for curing, thereby obtaining a first partial selective reflection layer having a selective reflection wave range with a center wavelength of 670 nm.

Similarly, a second cholesteric liquid crystal solution was applied directly to the first partial selective reflection layer and then subjected to aligning treatment (drying treatment) and curing treatment. Thus, a second partial selective reflection layer having a selective reflection wave range with a center wavelength of 600 nm was obtained. The procedure used for preparing the second cholesteric liquid crystal solution was the same as the procedure used for preparing the first cholesteric liquid crystal solution, provided that the nematic liquid crystal and the chiral agent were mixed in such a proportion that the resulting layer had a selective reflection wave range with a center wavelength of 600 nm.

Similarly, a third cholesteric liquid crystal solution was applied directly to the second partial selective reflection layer and then subjected to aligning treatment (drying treatment) and curing treatment. Thus, a third partial selective reflection layer having a selective reflection wave range with a center wavelength of 540 nm was obtained. The procedure used for preparing the third cholesteric liquid crystal solution was the same as the procedure used for preparing the first cholesteric liquid crystal solution, provided that the nematic liquid crystal and the chiral agent were mixed in such a proportion that the resulting layer had a selective reflection wave range with a center wavelength of 540 nm.

Similarly, a fourth cholesteric liquid crystal solution was applied directly to the third partial selective reflection layer and then subjected to aligning treatment (drying treatment) and curing treatment. Thus, a fourth partial selective reflection layer having a selective reflection wave range with a center wavelength of 470 nm was obtained. The procedure used for preparing the fourth cholesteric liquid crystal solution was the same as the procedure used for preparing the first cholesteric liquid crystal solution, provided that the nematic liquid crystal and the chiral agent were mixed in such a proportion that the resulting layer had a selective reflection wave range with a center wavelength of 470 nm.

Similarly, a fifth cholesteric liquid crystal solution was applied directly to the fourth partial selective reflection layer and then subjected to aligning treatment (drying treatment) and curing treatment. Thus, a fifth partial selective reflection layer having a selective reflection wave range with a center wavelength of 420 nm was obtained. The procedure used for preparing the fifth cholesteric liquid crystal solution was the same as the procedure used for preparing the first cholesteric liquid crystal solution, provided that the nematic liquid crystal and the chiral agent were mixed in such a proportion that the resulting layer had a selective reflection wave range with a center wavelength of 420 nm.

Thus, there was obtained a projection screen 1 comprising a polarized-light selective reflection layer composed of a laminate of the five partial selective reflection layers. Namely, the projection screen 1 obtained was that the first partial selective reflection layer (thickness 5 μm) having a selective reflection wave range with a center wavelength of 670 nm, the second partial selective reflection layer (thickness 4.5 μm) having a selective reflection wave range with a center wavelength of 600 nm, the third partial selective reflection layer (thickness 4 μm) having a selective reflection wave range with a center wavelength of 540 nm, the fourth partial selective reflection layer (thickness 3.4 μm) having a selective reflection wave range with a center wavelength of 470 nm, and the fifth partial selective reflection layer (thickness 2.7 μm) having a selective reflection wave range with a center wavelength of 420 nm were successively laminated to the substrate in the order mentioned. The size of the projection screen 1 was 60 inches (1200 mm×900 mm). The cholesteric liquid crystalline structure of each partial selective reflection layer of the polarized-light selective reflection layer in the projection screen 1 thus obtained was not in the state of planar orientation.

(Comparative Example)

The procedure of the above Example was repeated, provided that the polarized-light selective reflection layer was formed by laminating three partial selective reflection layers, thereby preparing a projection screen 2. Specifically, the projection screen 2 was that a first partial selective reflection layer (thickness 31 μm) for selectively reflecting light in the wave range for blue (B) color (light in a selective reflection wave range with a center wavelength of 440 nm), a second partial selective reflection layer (thickness 4 μm) for selectively reflecting light in the wave range for green (G) color (light in a selective reflection wave range with a center wavelength of 550 nm), and a third partial selective reflection layer (thickness 5 μm) for selectively reflecting light in the wave range for red (R) color (light in a selective reflection wave range with a center wavelength of 600 nm) were successively laminated to the substrate in the order mentioned. The size of the projection screen 2 was 60 inches (1200 mm×900 mm).

A commercially available, 60-inch (1200 mm×900 mm) matte screen was prepared as a projection screen 3.

(Results of Evaluation)

The projection screen 1, 2, 3 was set vertically to the floor. A projector was placed vertically to the projection screen 1, 2, 3, in parallel with the floor, at a point approximately 2.5 m distant from the projection screen.

Imaging light (a still image including white and black parts) was projected on the projection screen 1, 2, 3 from the projector, and the color of the black part of the image displayed on the projection screen 1, 2, 3 was observed.

As a result, on the projection screen 2, the black part of the image appeared reddish black. On the projection screen 3, the black part of the image was achromatic but not dark, so that the image contrast was low.

On the other hand, on the projection screen 1, the black part of the image appeared dark gray (achromatic color) and more perfect black. The image produced on the projection screen 1 had high contrast and was highly visible.

1. A projection screen for displaying an image by reflecting imaging light that is projected from an observation side, the projection screen comprising:
a polarized-light selective reflection layer that selectively reflects a specific polarized-light component,
wherein the polarized-light selective reflection layer has substantially a same reflectance for light in a wave range of at least 450 to 650 nm.

2. The projection screen according to claim 1, wherein the polarized-light selective reflection layer has a selective reflection wave range whose width between shorter and longer wavelength side ends, around a center wavelength, is 200 nm or more.

3. The projection screen according to claim 1, wherein the specific polarized-light component is right- or left-handed circularly polarized light.

4. The projection screen according to claim 1, wherein the specific polarized-light component is linearly polarized light of one vibration direction.

5. The projection screen according to claim 1, further comprising a diffusing element that diffuses light that is reflected from the polarized-light selective reflection layer.

6. The projection screen according to claim 1, wherein the polarized-light selective reflection layer itself has diffusing properties.

7. The projection screen according to claim 6, wherein the polarized-light selective reflection layer has a cholesteric liquid crystalline structure, and, owing to structural non-uniformity in the cholesteric liquid crystalline structure, diffuses the specific polarized-light component.

8. The projection screen according to claim 7, wherein the cholesteric liquid crystalline structure of the polarized-light selective reflection layer contains a plurality of helical structure parts whose helical axes extend in different directions.

9. The projection screen according to claim 7, wherein the cholesteric liquid crystalline structure of the polarized-light selective reflection layer has helical pitches that are continuously varied along a thickness of the layer.

10. The projection screen according to claim 1, wherein the polarized-light selective reflection layer is made from a material having a great birefringence value.

11. The projection screen according to claim 1, further comprising a substrate that supports the polarized-light selective reflection layer.

12. The projection screen according to claim 11, wherein the substrate is an absorptive substrate comprising a light-absorbing layer adapted to absorb light in a visible region.

13. The projection screen according to claim 11, wherein the substrate is a transparent substrate adapted to transmit at least part of light in a visible region.

14. The projection screen according to claim 1, wherein the polarized-light selective reflection layer comprises at least two laminated partial selective reflection layers having selective reflection wave ranges continuously overlapping each other, thereby having substantially a same reflectance for light in a wave range of at least 450 to 650 nm.

15. The projection screen according to claim 14, wherein an intermediate layer having barrier properties is provided between each neighboring two of the partial selective reflection layers in the polarized-light selective reflection layer.

16. The projection screen according to claim 14, wherein an intermediate layer having adhesion properties is provided between each neighboring two of the partial selective reflection layers in the polarized-light selective reflection layer.

17. The projection screen according to claim 1, further comprising a functional layer that contains at least one layer selected from a group consisting of a hard coat layer, an anti-glaring layer, an anti-reflection layer, an ultraviolet-light-absorbing layer and an antistatic layer.

18. The projection screen according to claim 17, wherein the functional layer is an anti-glaring layer composed of a layer with an irregularly roughened surface, isotropic with respect to refractive index.

19. The projection screen according to claim 18, wherein the anti-glaring layer is a TAC film with a matte surface.

20. The projection screen according to claim 1, wherein the polarized-light selective reflection layer has, on a side on which imaging light is projected, a roughened surface, by which the anti-glaring property is imparted to the polarized-light selective reflection layer.

21. A projection system comprising:
the projection screen according to claim 1; and
a projector that projects imaging light on the projection screen.
